(19) United States
(12) Patent Application Publication
(10) Pub. No.: US 2025/0126329 A1
(43) Pub. Date: Apr. 17, 2025

(54) Interactive Video

(71) Applicant: HIA Technologies, Inc., La Crescenta, CA (US)

(72) Inventors: Vacit Arat, La Cañada Flintridge, CA (US); Arnav Mukherjee, Lexington, MA (US); Bobbi Jolean Sheffield, Rockwell, TX (US); Joseph Coppola, Buffalo, NY (US); Alidad Ghiassi, Los Angeles, CA (US)

(21) Appl. No.: 18/915,301

(22) Filed: Oct. 14, 2024

Related U.S. Application Data
(60) Provisional application No. 63/590,450, filed on Oct. 15, 2023.

(51) Int. Cl. H04N 21/4722; H04N 21/2387

(52) U.S. Cl. CPC H04N 21/4722; H04N 21/2387

(57) ABSTRACT

Disclosed embodiments include two-way interactive video methods and computing systems configured to perform such methods. Some embodiments include (i) while first interactive video content played for a viewer within a playback window, receiving a question from the viewer of the first interactive video content; (ii) pausing playback of the first interactive video content within the playback window; (iii) while playback of the first interactive video content is paused within the playback window, determining a response based on (a) the received question and (b) information approved by a creator of the first interactive video content; (iv) after determining the response, causing playback of the response in an experience window within the playback window in which the first interactive video content is paused; and (v) after playing at least a portion of the response in the experience window, resuming playback of the first interactive video content within the playback window.

### CROSS-REFERENCE TO RELATED APPLICATIONS

This application claims priority to U.S. Provisional App. 63/590,450, titled “Interactive Video,” filed on Oct. 15, 2023, and currently pending; the entire contents of U.S. Provisional App. 63/590,450 are incorporated herein by reference.

This application also incorporates by reference the entire contents of U.S. application Ser. No. 18/322,134 titled “Digital Character Interactions with Media Items in a Conversational Session,” filed on May 23, 2023, and currently pending.

### OVERVIEW

Today, people record and post videos (e.g., YouTube, Vimeo, and other online platforms) that are entertaining, educational, and/or tutorial in nature. However, for videos that have been recorded and posted to online platforms, viewers are not able to interact with the video in real time. For example, with existing videos that have been recorded and posted to current online platforms, a viewer is not able to ask questions to people in the video, or to the author of the video. Similarly, neither the people in the video nor the video creators can answer questions within the video once the video has been posted to the platform. Instead, at best, “out-of-band” mechanisms such as chats, comments, discords, or other similar mechanisms allow video creators to watch for viewer questions, and in some instances, provide feedback to viewer questions. Even for online platforms that may provide chats, comments, discords, and/or other mechanisms, these out-of-band mechanisms require someone to monitor the content of the chats, comments, discords, etc. for viewer questions or other feedback. Once a viewer question has been identified on one of the out-of-band mechanisms, the video creator can provide a response to the viewer question. However, providing responses to viewer questions via these out-of-band mechanisms lacks real-time visual and verbal interaction between the viewer and the video. These current approaches have no way to dynamically modify playback of the video in any way (e.g., rewind/fast-forward to another part of the video that explains an answer) and/or redirect the viewer to another video with other information.

Embodiments disclosed herein include methods of creating interactive video and providing interactive video to viewers. In some embodiments, the video created and provided to viewers is (or at least includes) two-way interactive video that enables the viewer to interact with the video author, sometimes referred to herein as the content creator. Two-way interactive video that enables a viewer to interact with the video author in the manners described herein provides several advantages over existing video platforms.

For example, one advantage of some disclosed embodiments is that the interactive experience with the two-way interactive video occurs within the interactive video itself (e.g., within an experience window within the interactive video) as compared to existing video platforms that typically redirect the viewer to locations outside of the video window, another website or medium for the “interaction” such as the “out of band” chats, comments, discords, or other similar mechanisms described above. Additionally, some current video platforms embed links within a video, such as an embedded Uniform Resource Locator (URL) or other suitable link. When the viewer selects the link (via a mouse click, touch interface, or other suitable selection technique), the link triggers an action that routes the viewer to an experience outside of the video, such as another location on the same web page outside of the video, launching a separate window to display other digital media (e.g., print, graphics, etc.), launching a separate application (e.g., a PDF viewer, or other document viewer application), taking the viewer to a website or other URL destination. Taking the viewer to a different window, a different application, or a different website or other “out of band” experience outside of the original video has drawbacks for both the viewer and the author of the video. From the standpoint of the viewer, being routed to different windows, applications, and/or websites can cause confusion and/or result in a disjointed and unnatural viewing experience. Sometimes, it can be difficult for the viewer to get back to the original video from where the viewer was routed to the different window, application and/or website. From the standpoint of the video author, routing the viewer to a different window, application, and/or website makes it far more difficult to track how the viewer is interacting with the video content, which is particularly undesirable for educational and/or instructional videos, especially when the video author may want to user viewer interaction data to improve the educational/instructional content in future versions of the video.

Another advantage of some disclosed embodiments is that response(s) to the viewer's questions are provided by the author of the video as compared to existing video platforms where response(s) might in some instances be obtained and/or generated from unapproved sources (e.g., found on the web or other unapproved resources). For instance, when a viewer is routed to a different website from the video (in the manner described above), the author of the video may not be able to verify the accuracy of the information provided on the website. Also, some video platforms may incorporate chat interfaces driven by AI that answer questions (e.g., in a separate chat window) posed by viewers by itself without the video author having the opportunity to review and approve the answer before it is delivered. Further, such AI-driven responses may have been trained with information that has also not been verified by the video author, and such chat interfaces may give answers that are inconsistent with the context of the video or even wholly inaccurate, such as “hallucinations” or other nonsensical or inaccurate outputs. Providing inconsistent and/or inaccurate answers is particularly undesirable for healthcare, educational, and/or instructional videos. Further, providing inconsistent and/or inaccurate answers can be dangerous or even deadly for videos on certain topics, such as videos about repairing or servicing certain machinery, or videos with healthcare information.

Another advantage of some disclosed embodiments is that metrics or other information about an interaction between the viewer and the video can be provided back to the author of the video. In some instances, the metrics or other information about the interaction can be provided back to the author of the video in real-time or substantially real-time. The author can then use the metric(s) about the interaction(s) between the viewer(s) and the video to improve the viewing experience, including adding additional response(s) for future interactions. This is particularly advantageous for educational and/or instructional videos, particularly where the video author may want to use interaction metrics to improve the educational/instructional content in future versions of the video.

In addition to the benefits to both viewers and content creators summarized above and described elsewhere herein, the disclosed two-way interactive video systems and methods also provide technical improvements to the function and operation of the computing systems implementing the disclosed two-way interactive video solutions compared with existing approaches.

For example, and as mentioned above, the interactive experience with the two-way interactive video solutions disclosed and described herein occurs within the two-way interactive video itself (e.g., within an experience window within the two-way interactive video) as compared to existing approaches that take the viewer to a different window, a different application, a different website or other “out of band” experience separate from the original video. The disclosed embodiments where viewer interaction occurs within an experience window (or similar) of the two-way interactive video application require fewer inter-application communications (or perhaps no inter-application communications) as compared to existing approaches that take viewers to different processes, different windows, different applications, different websites or other “out of band” experiences separate from the original video. Inter-application communications in this context generally refers to control signaling and/or information sharing between the video player and other processes, windows, applications and/or websites to facilitate launching the external process, windows, application, and/or website and passing data (e.g., viewer data, session data, and so on) to the external process, window, application, and/or website.

Disclosed embodiments that do not launch external processes, windows, applications, or websites, need not perform inter-application signaling to launch such external processes, windows, applications, or websites or pass any data (e.g., viewer data, session data, etc.) to such external processes, windows, applications, or websites for processing by the external process, window, application, or website. Further, when viewers are not sent to an external process, window, application, or website in such disclosed embodiments, there is no need for the external process, window, application, or website to implement inter-application signaling to send the viewer back to the two-way interactive video player. By reducing (and in some cases eliminating) the need for inter-application signaling to facilitate transferring viewers between a video application and external processes, windows, applications, or websites some disclosed embodiments can be implemented less complicated program code and more efficient system architectures as compare to existing approaches that that require complicated inter-application signaling to take viewers to different processes, different windows, different applications, different websites or other “out of band” experiences separate from the original video.

At a high level, generating a two-way interactive video according to some embodiments includes (i) obtaining a base video (e.g., a video file, a video from YouTube or another video platform, a video live stream, etc.), (ii) obtaining interactive content for the base video, e.g., by receiving interactive content from a content creator (which may or may not be the same content creator of the base video) and/or generating interactive content with a generative model (e.g., a Generative Pre-trained Transformer (GPT) model or other suitable generative model), and (iii) publishing an interactive video that includes the base video and the interactive content. In some embodiments, publishing the two-way interactive video includes publishing the two-way interactive video on an interactive video platform, which can be accessible via a website, application, or similar. For example, in some embodiments, publishing the two-way interactive video on the interactive video platform may additionally include generating a link, QR code, or pointer to the interactive video so that the interactive video can be shared broadly on the Internet.

One important feature of the two-way interactive video disclosed and described herein is that a viewer of the two-way interactive video on the interactive video platform is able to ask questions during playback of the interactive video. After receiving a question from a viewer, the two-way interactive video platform in some instances pauses playback of the video, determines a response to the question, and provides the determined response to the viewer. In some instances, and as described further herein, the response from the two-way interactive video platform may be a follow up question back to the viewer. In such instances, the follow up question back to the viewer may seek further clarification of the viewer's original question, or may seek further information from the viewer to help select an appropriate answer to the viewer's original question.

For example, some embodiments include, among other features, while first interactive video content is being played within a playback window in Graphical User Interface (GUI) on an end-user computing device, receiving a question from a viewer of the first interactive video content. To pose a question to the interactive video, the viewer can type the question into a prompt or window or select the question from a list. In scenarios where the viewer is watching the first interactive video content on an end-user computing device that has a microphone either integrated with the device or at least associated with the device and configured to capture voice inputs, posing the question to the interactive video can additionally or alternatively include the viewer speaking the question. Similarly, in scenarios where the viewer is watching the first interactive video content on end-user computing device that has a camera either integrated with the device or at least associated with the device and configured to capture video, a video of the viewer posing the question can also be captured and perhaps used in connection with determining an appropriate response.

Regardless of the format (text, selection, voice, video, etc.) of the question posed to the interactive video, after receiving the question (or in some instances, after receiving an indication that the viewer wishes to pose a question), playback of the interactive video is paused. Then, a response to the question is determined based at least in part on the question. The response can include any one or more of (i) a text response displayed within the GUI (e.g., within an experience window), (ii) a voice response played via one or more speakers associated with the viewer's end-user device, (ii) a second video content played within the GUI (e.g., within the experience window), (iii) a Uniform Resource Locator (URL) displayed within the GUI (e.g., within the experience window), wherein the URL contains a link to information relating to the question, and/or (iv) an electronic document displayed within the GUI (e.g., within the experience window) and/or most any other type of digital information that can be displayed within the GUI (e.g., within the experience window).

After determining the response, and while playback of the first video content is paused, the response to the question is played back within the GUI. In some instances, playing back the response within the GUI includes playing the response within the same window (e.g., within the experience window) in which the first video content was playing before playback of the first video content was paused. In other instances, playing back the response within the GUI includes playing the response within a smaller window within the window in which the first video content was playing before playback of the first video content was paused.

In some examples, when the interactive video is played via a first computing device, the response may be played independent of the playback window in the GUI. For example, if the response is an audio-only response, then the response may be played via one or more speakers of the first computing device while playback of the interactive video is paused in the playback window in the GUI of the first computing device. In another example, the response may be played via a second computing device that is separate from the first computing device. In some scenarios, this may include playing an audio-visual response via a smart television while playback of the interactive video is paused in the playback window in the GUI of the first computing device. In other scenarios, this may include playing an audio-only response via a smart speaker while playback of the interactive video is paused in the playback window in the GUI of the first computing device. In operation, the first computing device may provide the response to the second computing device for playback, or the second computing device may obtain the response from a back-end platform (e.g., cloud server) for playback.

After at least a portion of the response to the question is played back within the playback window in the GUI, playback of the first video content is resumed. In some instances, playback of the first video content is resumed at the point where playback of the first video content was paused just before playing the response. In other instances, playback of the first video content is resumed at a different point during the first video content that is different than the point where playback of the first video content was paused just before playing the response.

Some embodiments additionally or alternatively include producing interactive video content. For example, some interactive video production embodiments include receiving first video content that includes video data and audio data. This first video content is the “base” video. Embodiments disclosed herein describe different ways of creating interactive content for the base video. As mentioned previously, and as described in detail herein, the interactive video includes the base video and the interactive content associated with the base video.

After receiving the first video content, some embodiments include obtaining at least one of a text transcription of the audio data and/or a text summary of the audio data component of the first video content.

The text transcription of the audio data and/or text summary of the audio data are stored in a knowledge base that is maintained for and associated with the first video content. The information contained in the knowledge base includes the interactive content to accompany the base video. The information contained in the knowledge base is also used in some instances to create and/or generate interactive content to accompany the base video. Details of the information stored in the knowledge base and how that information is used to further develop the knowledge base and provide responses to questions posed by viewers are described further herein.

In another aspect, disclosed herein is a computing system that includes a network interface, at least one processor, a tangible, non-transitory computer-readable medium, and program instructions stored on the non-transitory computer-readable medium that are executable by the at least one processor to cause the computing system to carry out the functions disclosed herein, including but not limited to the functions of the foregoing method.

In yet another aspect, disclosed herein is a non-transitory computer-readable storage medium provisioned with software that is executable to cause a computing system to carry out the functions disclosed herein, including but not limited to the functions of the foregoing method.

The systems and methods disclosed herein can be used in a wide variety of use cases.

In one example use case, the interactive video is an educational video where students can interact with the interactive video during playback to get answers to their questions, get additional related information, and so on. The questions posed by the students and the responses returned by the computing system can provide the students with additional content and explanation beyond the subject matter that could have been presented in an ordinary education video. For example, the responses to the student questions help the students understand the subject matter better and more quickly by giving the student supplemental material (e.g., additional video explanation, documents, links to related information, etc.) that is most relevant to that particular student.

In some instances, the response to the student question may be a follow-up question to elicit information from the student to help select an appropriate response. For example, if a student asks a question during an interactive video about music theory, the system's initial response may be a follow up question to the student which instrument the student is most familiar with playing and/or how long the student has been playing music. The system may provide a different answer to a student who primarily plays piano as compared to a student who primarily plays a wind instrument. Similarly, the system may provide a different answer to a beginner musician versus an intermediate or advanced musician. In this manner, follow up question(s) enable the system to provide tailored answers to individual students based on each student's knowledge, background, and experience.

In another example use case, the interactive video is a deposition video where a viewer can ask questions during playback of the video, and the computing system provides responses that provide further clarification and/or supplemental information. For example, when the witness is testifying about the content of a first document and refers to a second document, the viewer can ask a question about the second document. When the viewer asks about the second document, playback of the deposition video is paused, and the computing system can provide the viewer with a link to the second document and perhaps a brief audio overview of the second document. The viewer can additionally ask to see other testimony about the second document, perhaps from that witness or other witnesses. After the viewer is finished with viewing responses to the questions about the second document, playback of the deposition video resumes.

One of ordinary skill in the art will appreciate additional features and functions of the features described above as well as other potential use cases after reading the present disclosure.

### BRIEF DESCRIPTION OF THE DRAWINGS

FIG. 1 is a simplified block diagram that illustrates an example network in which the disclosed technology may be implemented according to some embodiments.

FIG. 2 is a simplified block diagram that illustrates some structural components that may be included in an example computing platform, according to some embodiments.

FIG. 3 is a simplified block diagram that illustrates some structural components that may be included in an example computing device, according to some embodiments.

FIG. 4A shows an example of interactive video content being played within a Graphical User Interface (GUI) according to some embodiments.

FIG. 4B shows an example of an input window via which a viewer of the interactive video content depicted in FIG. 4A can pose a question according to some embodiments.

FIG. 4C shows an example of a text response to the question posed by the viewer depicted in FIG. 4B according to some embodiments.

FIG. 4D shows an example of a video response to the question posed by the viewer depicted in FIG. 4B according to some embodiments.

FIG. 4E shows an example of an interactive video with an “Ask Me” button at the bottom of the interactive video playback GUI according to some embodiments.

FIG. 4F shows an example of an “Ask a Question” window launched within the interactive video playback GUI in response to activation of the “Ask Me” button depicted in FIG. 4E according to some embodiments.

FIG. 4G shows an example of a video response launched within the interactive video playback GUI in response to receiving a viewer selection of one of the “Common Questions” in the “Ask a Question” window depicted in FIG. 4F.

FIG. 4H shows another example of an “Ask a Question” window launched within the interactive video playback GUI in response to activation of the “Ask Me” button depicted in FIG. 4E according to some embodiments.

FIG. 4I shows an example of an interactive map launched within the interactive video playback GUI in response to receiving a viewer selection of one of the “Common Questions” in the “Ask a Question” window depicted in FIG. 4H.

FIG. 5 shows an example method for implementing interactive video according to some embodiments.

FIG. 6 shows an example method of creating and maintaining a knowledge base of interactive video content according to some embodiments.

FIG. 7 shows another example method for implementing interactive video according to some embodiments.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example System Configuration

The disclosed embodiments are generally directed to two-way interactive video and software for two-way interactive video, including (i) software that enables a viewer of the two-way interactive video to interact with the two-way interactive video and (ii) software that enables a content creator to generate the two-way interactive video.

As used herein, two-way interactive video refers to video that enables two-way interaction between the two-way interactive video and a viewer of the two-way interactive video. For simplicity, the two-way interactive video embodiments are sometimes referred to herein as just interactive video. Some educational and entertainment focused videos in the past have used on-screen icons that enable a viewer to navigate to different parts of the video. Further, some educational videos similarly include question/answer portions in a quiz type of format where questions about the video are presented to the viewer, and the viewer can select answers to the questions. In some examples, the video includes a chapter, section, or episode on a particular topic, and questions are posed to the viewer at the end of the chapter/section/episode that relate to the subject matter presented during the chapter/section/episode.

However, in these prior video examples, the video (perhaps in combination with associated software) poses questions to the viewer—the viewer cannot pose a question to the video in these prior systems. So, while the viewer may interact with these prior videos by, for example, navigating to a section of the video and/or answering quiz-type questions posed by the video, the interaction is fairly rudimentary.

By contrast, the two-way interactive video (in combination with associated interactive video software) embodiments disclosed herein enables the viewer to pose a question to the interactive video, and the interactive video (in combination with associated interactive video software) provides a response to the question posed by the viewer. In some instances, the response is an answer to the viewer's question. In other instances, the response may be a follow-up question to the viewer that seeks additional information about the viewer's question to help determine an appropriate answer. In another example, the response may direct the viewer to another part of the video that addresses the viewer's question.

Thus, the “interactive video” disclosed and described herein differs from prior video in that the interactive video disclosed and described herein enables the viewer to pose questions to the interactive video. Accordingly, in the context of the disclosed embodiments, the term interactive video generally refers to interactive video content and associated software that controls presentation of the interactive video, including (i) enabling viewers of the interactive video to pose questions to the interactive video, and (ii) providing responses to questions posed by the viewer in form of text, documents, links, pre-recorded video, instructions to skip to a part of the video that addresses the question, and/or responses by a digital character.

Thus, in the above-described respects, the “interactive video” disclosed and described herein amounts to “two-way interactive video” since viewers can pose questions to the interactive video and receive responses, and the video can pose questions to the viewer (as described herein).

As used herein, the viewer of interactive video generally refers to a person who is watching the interactive video on an end-user computing device, such as a smartphone, tablet computer, laptop computer, desktop computer, smart television, or any other computing device with a video screen and a user interface that is configured to enable the viewer to interact with the interactive video via any of the interaction methods disclosed herein.

Similarly, as used herein, the term content creator generally refers to a person or business entity that created and/or produced the interactive video. In some instances, the content creator may be one or more individuals shown in the video. However, in some instances, the individuals shown in the video might be actors who are separate from the content creator(s).

As used herein, a speaking character in an interactive video generally refers to an on-screen or off-screen (e.g., a narrator or voiceover) character who is speaking during an interactive video.

At a high level, aspects of the disclosed embodiments include or relate to software that enables a viewer to watch (and interact with) an interactive video. Aspects of the disclosed embodiments also include or relate to software that enables a content creator to create, generate, or otherwise produce interactive video content.

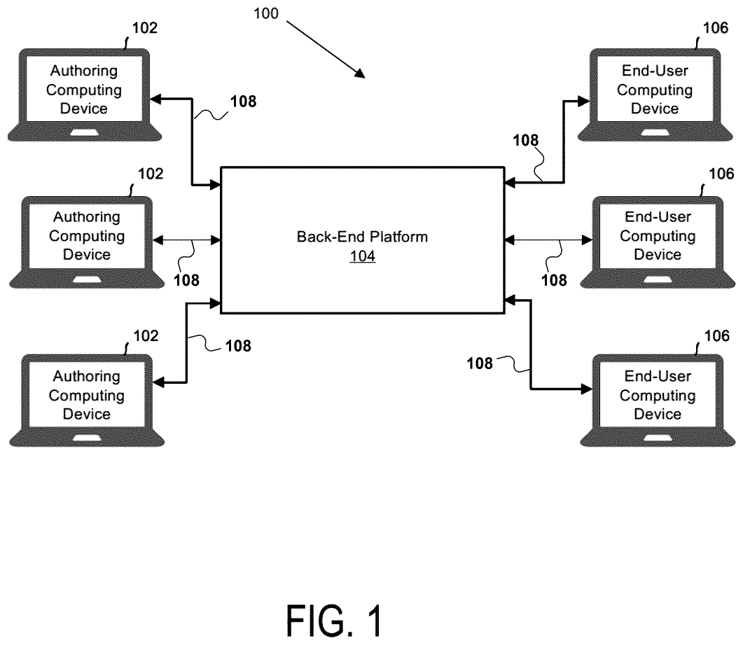

FIG. 1 shows a simplified block diagram of an example network environment 100 in which the disclosed technology may be implemented. As shown in FIG. 1, the example network environment 100 includes a plurality of authoring computing devices 102, a back-end platform 104, and a plurality of end-user computing devices 106. In some contexts, an authoring computing device may also act as an end-user computing device. Similarly, an end-user computing device may also act as an authoring computing device in some contexts.

In general, the back-end platform 104 may comprise one or more computing systems that have been provisioned with software for carrying out one or more of the functions disclosed herein for (i) enabling content creators (sometimes referred to herein as video authors) to generate interactive video content and (ii) controlling playback of interactive video via the end-user computing devices 106, including receiving questions posed by viewers, determining responses, and controlling playback of the responses via the end-user computing devices 106. The one or more computing systems of the back-end platform 104 may take various forms and may be arranged in various manners.

For instance, in some examples, the back-end platform 104 may comprise or at least connect to computing infrastructure of a public, private, and/or hybrid cloud-based system (e.g., computing and/or storage clusters) that has been provisioned with software for carrying out one or more of the functions disclosed herein. In this respect, the entity that owns and operates the back-end platform 104 may either supply its own cloud infrastructure or may obtain the cloud infrastructure from a third-party provider of “on demand” computing resources, such as, for example, Amazon Web Services (AWS) or the like. As another possibility, the back-end platform 104 may comprise one or more dedicated servers that have been provisioned with software for carrying out one or more of the functions disclosed herein, including but not limited to, for example, software for performing aspects of the interactive content generation (e.g., creating and maintaining knowledge bases for interactive videos) and software for controlling aspects of playing interactive videos (e.g., receiving and processing viewer questions, determining responses based on the contents of knowledge bases, and providing determined responses to end-user computing devices for playback/presentation to viewers).

In practice, the back-end platform 104 may be capable of serving multiple different parties (e.g., organizations) that have signed up for one or both of (i) access to software for creating interactive video content and/or (ii) access to software for viewing interactive video. Further, in practice, interactive video content created by a content creator via the disclosed interactive video content creation software using one of the authoring computing devices 102 may be later accessed by a viewer who has permission to access the respective interactive video content via an end-user computing device 106. In some instances, a front-end software component (e.g., a dedicated interactive video application, a web-based tool, etc.) is executed on an end-user computing device 106, and a back-end software component runs on the back-end platform 104 that is accessible to the end-user computing device 106 via a communication network such as the Internet. In operation, the front-end software component and the back-end software component operate in cooperation to cause the end-user computing device 106 to display the interactive video content to the viewer, process questions posed by the viewer via the end-user computing device 106, determine responses to the questions posed by the viewer, and cause the end-user computing device 106 to play (or otherwise provide or display) the response to the viewer. The back-end platform 104 may be configured to perform other functions in combination with the end-user computing devices 106 and/or authoring computing devices 102 as well.

In some instances, the back-end platform 104 may coordinate playback of a response across more than one end-user computing device. For example, in a scenario where the viewer is watching the interactive video on a laptop (a first end-user computing device), the back-end platform 104 may cause playback of an audio-only response via a smart speaker, a smart television, a smartphone, or other computing device (a second end-user computing device). Or in a scenario where the viewer is watching the interactive video on a smart television (a first end-user computing device), the back-end platform may cause playback of a response via the viewer's smartphone (a second end-user computing device).

Turning next to the authoring computing devices, the one or more authoring computing devices 102 may generally take the form of any computing device that is capable of running front-end software (e.g., a dedicated application, a web-based tool, etc.) for accessing and interacting with the back-end platform 104, such as front-end software for using the content authoring tool to create interactive video content. In this respect, the authoring computing devices 102 may include hardware components such as one or more processors, data storage, one or more communication interfaces, and I/O components, among other possible hardware components, as well as software components such as operating system software and front-end software that is capable of interfacing with the back-end platform 104. As representative examples, the authoring computing devices 102 could be any of a smartphone, a tablet, a laptop, or a desktop computer, among other possibilities, and it should be understood that different authoring computing devices 102 could take different forms (e.g., different types and/or models of computing devices).

Turning now to the end-user computing devices, the one or more end-user computing devices 106 may take the form of any computing device that is capable of running software for viewing interactive video content created by the authoring computing devices 102 via the content authoring tool and/or front-end software for accessing and interacting with the back-end platform 104. In some instances, an end-user computing device 106 may not necessarily include a screen for viewing interactive video content. For example, in some embodiments, the end-user computing device 106 may connect to another device that includes a screen for viewing interactive video content, such an AppleTV terminal that connects to a television, an Amazon Fire TV Stick that connects to a television, or similar type of computing device that connects to a television, computer terminal, or other device with a screen suitable for displaying interactive video.

While the examples described in this disclosure primarily focus on interactive video, some embodiments may instead include interactive audio, such as an interactive podcast. In operation, the features and functions of the interactive video embodiments disclosed herein are equally applicable to an interactive audio program, e.g., an interactive podcast. For example, a first end-user computing device plays the interactive audio to a listener. After detecting a question posed by the listener, playback of the interactive audio is paused, and a response is determined and then played to the listener. In some examples, the response may be an audio-only response played by the first end-user computing device. In other examples, the response may include video content played by the first end-user computing device, or perhaps video content played by a second end-user computing device.

Regardless of whether the interactive content is interactive video content (i.e., with video and audio) or interactive audio content (e.g., an interactive podcast), the end-user computing devices 106 may include hardware components such as one or more processors, data storage, one or more communication interfaces, and input/output (I/O) components, among other possible hardware components. The end-user computing devices 106 may also include software components such as operating system software and front-end software that is capable of interfacing with the back-end platform 104, among various other possible software components. As representative examples, the end-user computing devices 106 could be any of a smartphone, a tablet, a laptop, a desktop computer, smart television, smart speaker, networked microphone device, among other possibilities, and it should be understood that different end-user computing devices 106 could take different forms (e.g., different types and/or models of computing devices).

As further depicted in FIG. 1, the authoring computing devices 102, the back-end platform 104, and the end-user computing devices 106 are configured to interact with one another over respective communication paths 108. Each respective communication path 108 with the back-end platform 104 may generally comprise one or more communication networks and/or communications links, which may take any of various forms. For instance, each respective communication path 108 with the back-end platform 104 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 108 with the back-end platform 104 may be wireless, wired, or some combination thereof, and may carry data according to any of various different communication protocols. Although not shown, the respective communication paths 108 with the back-end platform 104 may also include one or more intermediate systems. For example, it is possible that the back-end platform 104 may communicate with the authoring computing devices 102 and/or the end-user computing devices 106 via one or more intermediary systems, such as a host server (not shown). Further, it is possible that the computing devices might communicate over a communication path 108 that does not include the back-end platform 104 as an intermediary. Any other communication path or communication method now known or later developed that is suitable for enabling data transmission between and among one or more (or all) of the authoring computing devices 102, the back-end platform 104, and the end-user computing devices 106 could be used as well.

Although not shown in FIG. 1, the back-end platform 104 may also be configured to receive data from one or more external data sources that may be used to facilitate functions related to the disclosed interactive video functions. A given external data source—and the data output by such data sources—may take various forms. One possible data source may be a server maintained by a third-party organization that may contain specific information that is not stored or maintained on the back-end platform 104, such as information that is specific to the third-party organization maintaining the server.

In some instances, the external data source may include (i) information that is access by the back-end platform 104 and/or the authoring computing device 102 and used for creating and/or managing interactive video content, including but not limited to information used for creating and/or maintaining knowledge bases for individual interactive videos, and/or (ii) information that is accessed by the back end platform 104 and/or end-user computing device 106 and used in connection with determining and/or generating responses to questions posed by viewers. As one example, where the third-party organization is a medical organization, specific information that is stored on the third-party server and accessed by the back end platform 104 to determine and/or to generate a response may include instructions for how to administer or take a given drug, as well as possibly precautionary information regarding the given drug. As another example, where the third-party organization is a toy manufacturer, specific information that is stored on the third-party server and accessed by the back end platform 104 to determine and/or generate a response may include marketing information about a given toy. Various other examples also exist.

It should be understood that the network environment 100 is one example of a network environment in which embodiments described herein may be implemented. Numerous other arrangements are possible and contemplated herein. For instance, other network environments may include additional components not pictured and/or more or fewer of the pictured components.

In practice, and in line with the example configuration above, the disclosed interactive video content authoring software may be running on one of the authoring computing devices 102 of a content creator who may wish to create interactive video content. The interactive video content created may then be viewed by a viewer via one of the end-user computing devices 106. Alternatively, the functions carried out by one or both of the authoring computing device 102 or the end-user computing device 106 may be carried out via a web-based application that is facilitated by the back-end platform 104. Further, the operations of the authoring computing device 102, the operations of the back-end platform 104, and/or the operations of the end-user computing device 106 may be performed by a single computing device. Further yet, the operations of the back-end platform 104 may be performed by more than one computing device. For example, some of the operations of the back-end platform 104 may be performed by the authoring computing device 102, while others of the operations of the back-end platform 104 may be performed by the end-user computing device 106, or perhaps by several end-user computing devices in the manner described previously.

### II. Example Platform

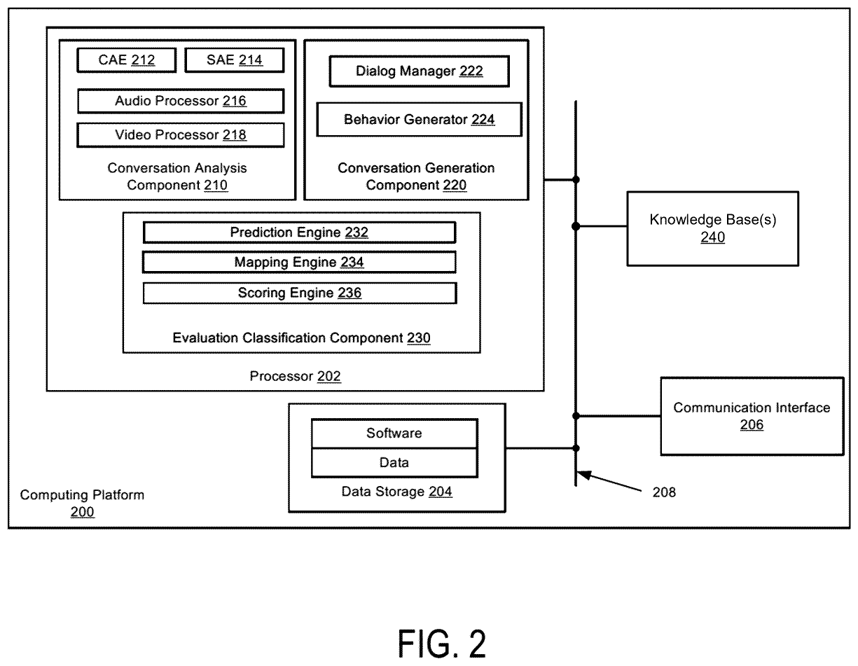

FIG. 2 is a simplified block diagram illustrating some structural components that may be included in an example computing platform 200, which could serve as the back-end platform 104 of FIG. 1. In line with the discussion above, the computing platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid network, or some other wired and/or wireless connection mechanism.

The processor 202 comprises one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In some embodiments, the processor 202 comprises processing components that are distributed across a plurality of physical computing devices connected via a network, such as a computing cluster of a public, private, or hybrid networks.

In some example configurations, and as shown in FIG. 2, the processor 202 includes a conversation analysis component 210, a conversation generation component 220, and an evaluation classification component 230.

Generally speaking, in some embodiments, the conversation analysis component 210 is configured to analyze and interpret inputs received from an end-user computing device 106. For instance, the conversation analysis component 210 may be configured to analyze audio of a question posed by the viewer, e.g., when the viewer speaks the question and a microphone at the end-user computing device 106 captures the audio of the viewer's question. In some instances, a camera at the computing device 106 may additionally capture video of the viewer's question. In some embodiments, the end-user computing device 106 may analyze the captured audio (and/or captured video) and convert the audio to text (e.g., using speech-to-text software residing on the end-user computing device 106). In other embodiments, however, the end-user computing device 106 may record audio (and/or video) of the viewer's question, and send the recorded audio (and/or video) to the back-end platform 104 for processing, including converting the audio into text. In some embodiments where the back-end platform 104 comprises the computing platform 200, the conversation analysis component 210 is configured to analyze the audio and generate text from the recorded audio.

The conversation analysis component 210 may take various forms. In some examples, the conversation analysis component 210 includes a content analysis engine (“CAE”) 212, a sentiment analysis engine (“SAE”) 214, an audio processor 216, and a video processor 218. The CAE 212 may be configured to analyze processed audio and/or video data to interpret a question posed by the viewer. In some instances, various natural language processing (NLP) methods may be used to capture the viewer's question and parse the viewer's question to identify key words and/or phrases that can be used to determine and/or generate an appropriate response to the question.

The SAE 214 may be configured to analyze processed audio and/or video data to capture additional information about the viewer, beyond the literal meaning of the question posed by the viewer, such as the viewer's sentiment. For example, in some implementations, the viewer's voice fluctuations, tone, pauses, use of filler words, and/or use of corrective statements can be used to identify levels of stress, discomfort, or confusion. In some implementations, the SAE 214 may be configured to analyze video data (or features identified from the video data) to determine various characteristics or observations about the viewer, examples of which may include the viewer's comfort level, personality trait, mood, ability to make eye contact, stress level, emotional state, and/or expressiveness, among other examples.

In some instances, analyzed sentiments can be used in real-time to help determine an appropriate response to the viewer's question in a variety of ways. For example, based on an analyzed sentiment, a digital character configured to provide a response to the viewer's question may become more or less chatty, more or less friendly, and/or more or less expressive. The changes in the behavior of a digital character can then be used to further analyze the viewer's response to the changing behavior.

The audio processor 216 may be configured to process an audio recording of the question posed by the viewer. In some implementations, the audio processor 216 may be configured to analyze the ambient background noise against the viewer's question in order to isolate the background noise and parse the beginning of the viewer's question as well as the end of the viewer's question. In other implementations, the audio processor 216 may be configured to use various continuous speech recognition techniques known in the art to parse the beginning and the end of a viewer's question.

Further, in some implementations, the audio processor 216 may employ various methods to convert the audio data into an interpretable form, such as Automatic Speech Recognition (ASR). In other implementations, the audio processor 216 may use a speech-to-text (STT) process to produce textual outputs that can be used for determining a response to the viewer's question. In some instances, the audio processor 216 may apply filters to the audio data (and/or to textual outputs generated from the audio data) to edit unnecessary elements, such as pauses, filler words, and/or corrected statements.

The video processor 218 may be configured to process video data from video of the viewer's question. In some instances, the video processor 218 is used to process video from a conversational session between the viewer and a digital character that is configured to provide a response to the viewer's question. For example, in some embodiments, the response to the viewer's question may include a conversation between the viewer and a digital character. Conversations with a digital character are described in detail in U.S. application Ser. No. 18/322,134, titled “Digital Character Interactions with Media Items in a Conversational Session,” filed on May 23, 2023. The entire contents of U.S. application Ser. No. 18/322,134 are incorporated herein by reference.

In some implementations, the video processor 218 may be used to analyze video for visual cues that may not be readily apparent in the audio data, such as a viewer's body language. In some instances, the video processor 218 may employ various machine learning methods, such as convolutional neural networks, recurrent neural networks, and/or capsule networks, to analyze video segments and/or captured images to identify features that can be used to analyze a viewer's body language.

One of ordinary skill in the art will appreciate that the conversation analysis component 210 may take various other forms and may include various other elements as well.

In accordance with the present disclosure, the conversation generation component 220 may be configured to generate a script for a digital character in scenarios where the response to the viewer's question includes a conversation with a digital character. The script can be generated based on a variety of different factors, such as information about the subject matter of the interactive video provided by the content creator, and in some instances, information about the subject matter of the interactive video obtained from third party sources.

In some examples, the script may be generated dynamically based on the content and/or context of the viewer's question, including the content, sentiment, and/or other factors identified from the viewer's question. In certain implementations, the content creator may manually author a script that is used for one or both of (i) a response that is displayed (in text form), played in audio form, and/or played in video form (ii) providing a conversational session between a digital character and the viewer. In some instances, using the authored script during a conversation session between the digital character and the viewer may involve fine-tuning existing content to convey information in a certain way, including (but not limited to) a positive or negative disposition of the digital character, and/or emphasis of a certain word or phrase, etc. In this respect, the conversation generation component 220 may take various forms.

As one example, the conversation generation component 220 may include a dialog manager 222 and a behavior generator 224. The dialog manager 222 may be configured to generate dialog that is to be presented to the viewer as at least part of the response provided to the viewer's question. For instance, the dialog manager 222 may be configured to generate a textual script that can be provided in audio or text form at the authoring computing device 102 and/or the end-user computing device 106. In some implementations, the script may be selected from a set of predefined scripts. In other implementations, the script may be generated dynamically using machine learning methods including, but not limited to, generative adversarial networks (GANs), recurrent neural networks (RNNs), capsule networks, and/or restricted Boltzmann machines (RBMs).

In some embodiments where the response includes a conversational session between the viewer and the digital character, the behavior generator 224 may be configured to generate behaviors for the digital character that converses with the viewer. For instance, the behavior generator 224 may be configured to generate randomized behaviors and gestures to create a sense of realism during a conversational session between the digital character and the viewer. In some implementations, such behaviors may be generated based on machine learning methods, such as generative adversarial networks (GANs) and/or Restricted Boltzmann Machines (RBMs). In other implementations, behaviors may be generated in a standardized format for describing model animations, such as Behavioral Markup Language (BML).

In some embodiments, the behavior generator 224 may receive information about the viewer as input to the behavior generation 224. In certain embodiments, behaviors for a digital character may be generated to mimic the body language of the viewer to help develop rapport between the viewer and the digital character. For instance, the behavior generator 224 may provide movements and postures to indicate that the digital character is listening, waiting for further clarification, processing the viewer's subsequent/follow-up questions, or (temporarily) disengaged from the conversation with the viewer.

In some embodiments, the behavior generator 224 can identify facial expressions to indicate emotions, such as confusion, agreement, anger, happiness, and/or disappointment. In a variety of embodiments, the behavior generator 224 may be configured to generate customized behaviors for the digital character, which may be based on a variety of factors, such as character, personality archetype, and/or culture.

One of ordinary skill in the art will appreciate that the conversation generation component 220 may take various other forms and may include various other elements as well.

The evaluation classification component 230 may take various forms as well. In general, the evaluation classification component 230 may be configured to evaluate a conversational session between the viewer and the digital character. For instance, the evaluation classification component 230 may be configured to evaluate the viewer's reaction time to a response provided by the digital character, a user's stress level, knowledge, and/or competency. The evaluation may be performed during a conversational session between the viewer and the digital character and/or after a conversational session between the viewer and the digital character has ended.

In some implementations, the evaluations of a conversational session between the viewer and the digital character can be used to train a model to adjust future conversational sessions between viewers and the digital character. Adjustments for the future conversational sessions may include changing the digital character's behaviors, reactions, gestures, and responses that are generated based on the viewer's question(s).

As shown in FIG. 2, the evaluation classification component 230 may include a prediction engine 232, a mapping engine 234, and a scoring engine 236. The prediction engine 232 may be configured to make predictions about the viewer involved in a conversational session with a digital character, such as the user's stress level, knowledge, and/or competency.

The scoring engine 236 may be configured to generate scores for the viewer involved in the conversational session with the digital character that can be used to summarize various aspects of the viewer, such as the user's personality traits, technical skills, knowledge, and/or soft skills. In some implementations, scoring engines can also include various statistics related to a conversational session, including the viewer's response time, length of sentences, and/or vocabulary diversity.

Although the scoring engine 236 is described as part of the computing platform 200, in some implementations, the scoring engine 236 may be provided by a third party system that analyzes various characteristics provided by the computing platform 200 to generate a score. For example, in some cases, a third party system may be used to generate personality scores and/or technical competence scores based on text of the viewer's conversation with the digital character.

The mapping engine 234 may be configured to identify scores for individual characteristics of the viewer and map them to criteria to be reported for a conversational session summary. For example, a score for friendliness of the viewer, which may be generated by the scoring engine 236 based on various factors (e.g., smiling, voice tone, language, and eye contact, etc.), may be mapped to a criteria to report the level of friendliness of the viewer involved in the conversational session with the digital character.

One of ordinary skill in the art will appreciate that the evaluation classification component 230 may take various other forms and may include various other elements as well. Further, one of ordinary skill in the art will appreciate that the processor 202 may comprise other processor components as well.

Some embodiments may not include one or more of the conversation analysis component 210, conversation generation component 220, or the evaluation classification component 230.

As further shown in FIG. 2, the computing platform 200 may also include data storage 204 that comprises one or more tangible, non-transitory computer-readable storage mediums, examples of which may include volatile storage mediums such as random-access memory (RAM), registers, cache, etc. and non-volatile storage mediums such as read-only memory (ROM), a hard-disk drive, a solid-state drive, flash memory, an optical-storage device, etc. In line with the discussion above, it should also be understood that the data storage 204 may comprise computer-readable storage mediums that are distributed across a plurality of physical computing devices connected via a network, such as a storage cluster of a public, private, or hybrid cloud-based storage systems.

In operation, the data storage 204 may be provisioned with software components that enable the computing platform 200 to carry out one or more of the interactive video functions disclosed herein. These software components may generally take the form of program instructions that are executable by the processor 202 to carry out the disclosed functions, which may be arranged together into software applications, virtual machines, software development kits, toolsets, or the like. Further, the data storage 204 may be arranged to store data in one or more databases, file systems, or the like. The data storage 204 may take other forms and/or store data in other manners as well.

The communication interface 206 may be configured to facilitate wireless and/or wired communication with external data sources and/or computing devices, such as the authoring computing device 102 and/or the end-user computing device 106 in FIG. 1. Additionally, in an implementation where the computing platform 200 comprises a plurality of physical computing devices connected via a network, the communication interface 206 may be configured to facilitate wireless and/or wired communication between these physical computing devices (e.g., between computing and storage clusters in a cloud network). As such, the communication interface 206 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wireless and/or wired communication. The communication interface 206 may also include multiple communication interfaces of different types. Other configurations are possible as well.

Computing platform 200 additionally includes one or more knowledge bases 240. In operation, the knowledge base(s) 240 may be part of the data storage 204 or a separate data storage configured to house the contents of the knowledge base(s) 240. In some embodiments, the knowledge base(s) 240 may be separate from the computing platform 200, but accessible by the computing platform 200 via the communication interfaces 206.

In some embodiments, each interactive video has its own knowledge base. In other embodiments, several related interactive videos may share a common knowledge base.

In operation, an individual knowledge base 240 comprises data that the computing platform 200 (individually or in combination with one or more other computing devices, e.g., the end-user computing device 106) uses to determine responses to questions posed by viewers of the interactive video.

In some embodiments, the knowledge base 240 for an individual interactive video comprises data associated with the interactive video that has been provided or approved by the content creator. For example, in some instances, the data associated with the interactive video provided or approved by the content creator includes one or more (or all) of: (i) a library of expected questions relating to the individual interactive video, (ii) a library of pre-recorded video responses to expected questions relating to the individual interactive video, including pre-recorded video follow-up questions (e.g., a response may include a follow up question as explained in further detail elsewhere herein) relating to the expected questions; (iii) a library of prepared text-based responses to expected questions relating to the individual interactive video, including prepared text-based follow up questions relating to the expected questions; (iv) a library of prepared voice responses to expected questions relating to the individual interactive video, including prepared voice-based follow up questions relating to the expected questions; (v) a library of text-based content corresponding to the individual interactive video, including but not limited to a text transcription or text summary of the individual interactive video; (vi) a library of one or more presentations, illustrations, and/or other documents related to the individual interactive video; and/or (vii) a library of Uniform Resource Locators (URLs) pointing to information related to the individual interactive video.

In some embodiments, the knowledge base 240 additionally or alternatively includes data about the interactive video that is generated by the computing platform 200.

For example, in some embodiments, one or more generative models can be used to develop both (i) potential questions and (ii) potential responses to questions. In such embodiments, the potential questions and the potential responses that are generated by the generative model can be (i) added to the knowledge base 240 and (ii) used when determining responses to questions posed by viewers. In some embodiments, the generative model comprises a Generative Pre-trained Transformer (GPT) model. However, any generative model suitable for generating questions and responses for subject matter based on data comprising information about the interactive video could be used instead of or in addition to the GPT model.

In operation, the generative model can be trained with one or more (or all) of: (i) a text transcription of the audio data of the interactive video; (ii) a text summary of the audio data of the interactive video; (iii) a text summary of the video data of the interactive video; (iv) data provided by a creator of the interactive video, such as questions and responses prepared by the content creator, including (a) pre-recorded video responses to expected questions relating to the interactive video, (b) prepared text-based responses to expected questions relating to the interactive video, and/or (c) prepared voice responses to expected questions relating to the interactive video; (v) text-based content corresponding to the interactive video; (vi) one or more presentations or other documents associated with to the interactive video; (vii) one or more Uniform Resource Locators (URLs) pointing to information related to the interactive video; (viii) data obtained from Internet searches of keywords extracted from one or both of the text transcription of the audio data of the interactive video and/or the data provided by the creator of the interactive video; (ix) text from viewer comments relating to the interactive video, (x) prior questions received from viewers of the interactive video; (xi) prior responses provided by the computing system to prior questions received from viewers of the interactive video; and/or (xii) pre-generated questions and/or pre-generated responses that have been previously generated by the generative model.

In some embodiments, the generative model can be trained with less than all of the categories of data listed above to generate questions and/or responses for adding to the knowledge base.

For example, in some embodiments, the training data used to train the generative model includes one or more of: (i) a text transcription of the audio data of the interactive video; (ii) a text summary of the audio data of the interactive video; or (iii) a text summary of the video data of the interactive video. In some embodiments where the content creator provides supplemental materials to accompany the interactive video (e.g., technical documents, presentations, journal papers, and/or other materials prepared by or at least provided by the content creator), the training data may additionally include text transcriptions and/or text summaries of the supplemental materials as well.

In another example, the training data used to train the generative model includes one or more of: (i) a text transcription of the audio data of the interactive video; (ii) a text summary of the audio data of the interactive video; (iii) a text summary of the video data of the interactive video; (v) data provided by the creator of the interactive video, such as questions and responses prepared by the content creator, including (a) pre-recorded video responses to expected questions relating to the interactive video, (b) prepared text-based responses to expected questions relating to the interactive video, and/or (c) prepared voice responses to expected questions relating to the interactive video; (v) text-based content provided by the content creator that corresponds to the interactive video; and/or (vi) one or more presentations or other documents associated with to the interactive video.

In yet another example, the training data used to train the generative model includes one or more of: (i) a text transcription of the audio data of the interactive video; (ii) a text summary of the audio data of the interactive video; (iii) a text summary of the video data of the interactive video; (iv) data provided by a creator of the interactive video, such as questions and responses prepared by the content creator, including (a) pre-recorded video responses to expected questions relating to the interactive video, (b) prepared text-based responses to expected questions relating to the interactive video, and/or (c) prepared voice responses to expected questions relating to the interactive video; (v) text-based content corresponding to the interactive video; and/or (vi) data obtained from Internet searches of keywords extracted from one or both of the text transcription of the audio data of the interactive video and/or the data provided by the creator of the interactive video.

In some embodiments, specific seed data is used for generating questions and responses. For examples, in some instances, the seed data includes one or more (or all) of: (i) text from viewer comments relating to the interactive video; (ii) prior questions received from viewers of the interactive video; (iii) prior responses provided by the computing system to prior questions received from viewers of the interactive video; and/or (iv) keywords and/or key phrases extracted from any one or more of (a) the text from viewer comments relating to the interactive video, (b) the prior questions received from viewers of the interactive video, and/or (c) prior responses provided by the computing system to prior questions received from viewers of the interactive video.

Based on the training data, the generative model can generate potential questions that viewers might ask about the interactive video to supplement any potential questions that may have been prepared by the content creator. Similarly, based on the training data, the generative model can also generate potential follow up questions to potential questions that viewers might ask to supplement any follow up questions that may have been prepared by the content creator. In some instances, the content creator may review and approve (or reject) individual questions and follow up questions (that are generated by the generative model) based on the content creator's knowledge of the subject matter addressed in the interactive video. In some instances, the content creator may additionally edit/revise certain questions and/or follow up questions for accuracy and/or relevance. Approved questions and follow up questions (including perhaps questions and follow up questions revised by the content creator) can then be added to the knowledge base 240.

Also, based on the training data, the generative model can generate potential responses to one or both of (i) questions prepared by the content creator and/or (ii) questions generated by the generative model (and perhaps also approved by the content creator). In some instances, the content creator may review and approve (or reject) individual responses based on the content creator's knowledge of the subject matter in the interactive video. In some instances, the content creator may additionally edit/revise certain responses for accuracy, organization, and/or other considerations. Approved responses (including perhaps responses revised by the content creator) can then be added to the knowledge base 240. After adding generated responses to the knowledge base 240, the knowledge base 240 may include both (i) prepared responses provided by (and/or previously approved by) the content creator and (ii) responses generated by the generative model that have also perhaps been approved and/or revised by the content creator. In operation, any of the responses (i.e., responses prepared by the content creator and responses generated by the generative model) can be searched and selected when the computing system is determining a response based on a question posed by a viewer.

Thus, in some embodiments, the data associated with the interactive video generated by the computing platform 200 and stored in the knowledge base 240 additionally includes one or more (or all) of: (i) a library of generated questions and follow-up questions relating to the individual interactive video, (ii) a library of generated video responses to be delivered to the viewer via a digital character; (iii) a library of generated text-based responses to expected questions relating to the individual interactive video; and/or (iv) a library of generated voice responses to expected questions relating to the individual interactive video.

In some embodiments, generating and/or maintaining the knowledge base 240 for an individual interactive video includes the computing platform 200 receiving expected questions from the content creator (or perhaps generating expected questions with an appropriately trained generative model), receiving prepared responses to the questions from the content creator (or perhaps generating prepared responses with the appropriately trained generative model), and associating individual expected questions with individual prepared responses. In some instances, individual responses (prepared by the content creator or generated by the generative model) may be associated with several different questions (prepared by the content creator or generated by the generative model). In some instances, actual questions asked by viewers can be added to the knowledge base 240 and associated with one or more prepared and/or generated responses, and individual prepared and/or generated responses can be associated with several different actual received questions stored in the knowledge base 240.

For example, in some embodiments, generating and/or maintaining the knowledge base 240 for an individual interactive video includes (i) receiving pre-recorded video responses from a creator of the interactive video, and associating individual pre-recorded video responses with one or more expected questions in the knowledge base 240, and (ii) receiving text-based responses from the creator of the interactive video, and associating individual text-based responses with one or more expected questions in the knowledge base 240. In other examples, generating and/or maintaining the knowledge base 240 for an individual interactive video additionally or alternatively includes (i) generating one or more questions using a generative model trained with a dataset comprising data corresponding to the interactive video, and storing the one or more questions in the knowledge base 240, and (ii) generating one or more responses to one or more questions using the generative model trained with the dataset comprising data corresponding to the interactive video, and storing the one or more responses in the knowledge base 240.

Further aspects of generating and/or maintaining one or more knowledge bases associated with one or more interactive videos are described further herein.

In operation, and as also explained below, the contents of the knowledge base 240 can be used in connection with determining responses to questions posed by viewers of the interactive video. For example, in some instances, determining a response includes selecting a response from a set of prepared (and/or previously generated) responses stored in the knowledge base 240 for the interactive video. In other instances, determining a response includes using a generative model (e.g., GPT or similarly suitable model) trained with the contents of the knowledge base 240 to generate a response.

Examples where determining the response includes selecting a response from a set of prepared (and/or previously generated) responses stored in the knowledge base 240 may comprise one or more of (i) extracting one or more keywords and/or key phrases from the question posed by the viewer, (ii) using the extracted keywords and/or key phrases to search the set of prepared (and/or previously generated) responses, (iii) obtaining search results based on the search, where the search results include one or more prepared (and/or previously generated) responses from the set of prepared (and/or previously generated) responses stored in the knowledge base 240, (iv) scoring each search result based on the extent to which keywords and/or key phrases associated with the search result matches keywords and/or key phrases extracted from the question posed by the viewer, and (v) selecting the search result with the highest score as the response. In some embodiments, selecting a response from the set of prepared (and/or previously generated) responses stored in the knowledge base 240 includes selecting the response from a set of predefined responses that both (i) correspond to one or more predefined questions with semantic similarity to the question posed by the viewer and (ii) meet a set of predefined criteria (e.g., confidence threshold(s)).

In some instances, rather than selecting the search result with the highest score as the response, other factors may be used to select a search result for the response. For example, in some instances where the viewer may have a preference for video responses rather than other types of responses, selecting a response from the search results may instead include selecting the highest-scoring video response from the search results even if another response (e.g., an audio-only response) might have a higher score than the highest-scoring video response.

Instead of selecting the highest scoring response (or type of response) from the search results, some embodiments may include selecting a response that has a score higher than some threshold score, e.g., a score on a scale of 1 to 100 or another suitable scale. For example, if the search results include 10 candidate responses, where 5 of the candidate responses have a score over 90 (representing a greater than 90% match with the keywords and/or key phrases extracted from the question posed by the viewer), then any of the 5 candidate responses are likely satisfactory. Rather than just selecting the highest-scoring response, one of the 5 candidate responses with a score over 90 is selected and presented to the viewer.

Selecting one of several high-scoring candidate responses above a minimum threshold (e.g., 90 on a 1-100 scale or some other suitable confidence threshold) can be advantageous for embodiments that additionally include asking the viewer to rate the quality of the answer provided to the question posed. For example, by providing high-scoring responses (above the minimum threshold) to viewers (rather than only the highest-scoring response), and then gathering feedback on the responses provided, each response's feedback can be stored in the knowledge base 240 and used in connection with selecting responses in the future. In operation, viewer feedback on responses can be used as another metric via which to score and/or rank responses during the course of generating responses to questions posed by viewers. In some examples, the feedback may additionally or alternatively include data on what the questions viewers posed, the responses to the posed questions, how the viewers reacted to the responses to the posed questions, how engaged the viewers were during the course of watching the interactive video, posing questions, and receiving responses.

In some instances, when attempting to identify (and select) a response from the set of prepared (and/or previously generated) responses stored in the knowledge base 240, none of the prepared (and/or previously generated) responses may score sufficiently high for selection and presentation to the viewer. In such an instance, some embodiments include notifying the content creator (e.g., via email, text message, or other suitable notification method) of the question so that the content creator can review the question and provide a response. For example, some such embodiments include notifying the content creator that the question could not be answered from the set of prepared answers. And if (or when) the content creator responds with an answer, the answer can be added to the set of prepared answers for future use. If the content creator responds while the viewer is still watching the interactive video, some embodiments additionally include providing the answer to the viewer during the viewer's interactive video session, which may include pausing the interactive video and providing the answer to the viewer, or perhaps including the answer during a future opportunity to provide an answer (e.g., when the viewer asks another question).

As mentioned above, in some embodiments, determining a response includes using a generative model (e.g., GPT or similarly suitable model) trained with the contents of the knowledge base 240 to generate a response to a viewer question. As described previously, some embodiments use a generative model to generate responses (or at least help with generating responses) to expected questions, and then store those generated responses in the knowledge base 240 so that the knowledge base 240 for an individual interactive video includes both (i) prepared responses provided the content creator and (ii) responses generated by the generative model (and perhaps revised and/or approved by the content creator).

However, some embodiments may additionally use a generative model to also generate responses in “real time.” In this context, using a generative model to generate a response in “real time” differs from using the generative model to “pre-generate” responses that are stored in the knowledge base 240. In particular, “real time” responses are generated to provide a response to a pending viewer question whereas “pre-generated” responses are generated and stored in the knowledge base as interactive content associated with the video before the viewer starts watching the interactive video.

For example, if after searching the knowledge based 240 for a prepared (or pre-generated) responses, no prepared (or pre-generated) response has a score above some minimum threshold (e.g., above about 90 on a scale of 1-100, or some other suitable threshold), then some embodiments may include generating a response using the generative model. In operation, once the generative model has been trained with the contents of the knowledge base, the viewer question can be provided to the generative model, which will generate a response based on the viewer question.

In some examples where the response generated by the generative model is a text response, the text response can be provided in the GUI for the viewer to read.

Alternatively, the text response from the generative model can be used as a script that is converted into an audio response. In some instances, the script can be read in the same voice as a speaking character in the interactive video. The speaking character may be a speaking character appearing in the interactive video or a narrator who is heard but not seen in the interactive video. Alternatively, the script could be read in a different voice.

In some instances, the text response from the generative model can be used as a script for a digital character to present to the viewer. In some examples, the digital character may be a virtual representation of a speaking character appearing in the interactive video. For example, if the interactive video depicts a technician describing how to repair a machine, the digital character may be a virtual representation of the technician.

In other examples, the digital character may not be a virtual representation of the speaking character, but instead, some other digital character. In some embodiments, the digital character used for a particular interactive video is based on the subject matter of the interactive video. For example, if the subject matter is related to air conditioning repair, then the digital character used for the interactive video may be an air conditioning repairman. In such scenarios, the digital character may be configured to (i) present responses to questions based on the contents of the knowledge base 240, (ii) engage in general conversation (e.g., chit chat) with the viewer, and (iii) engage in conversation with the viewer on topics from a broader knowledge base relevant to air conditioning, heating, and air conditioning and heating repair more generally.

Although not shown, the computing platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with the computing platform 200.

It should be understood that the computing platform 200 is one example of a computing platform that may be used with the embodiments described herein. Numerous other arrangements are possible and contemplated herein. For instance, other computing platforms may include additional components not pictured and/or more or fewer of the pictured components.

### III. Example Computing Device

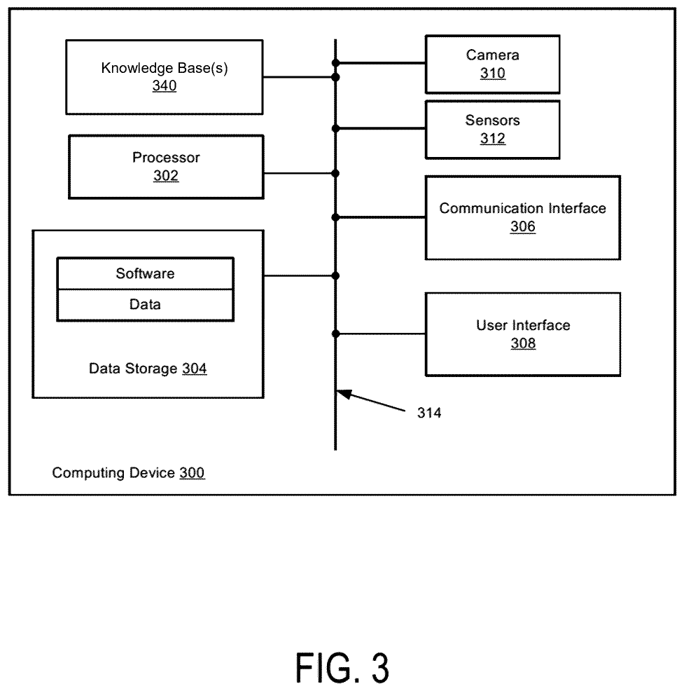

FIG. 3 is a simplified block diagram illustrating some structural components that may be included in an example computing device 300, which could serve as an authoring computing device 102 and/or an end-user computing device 106 of FIG. 1.

The computing device 300 comprises one or more processors 302, data storage 304, a communication interface 306, a user interface 308, one or more cameras 310, and sensors 312, all of which may be communicatively linked by a communication link 314 that may take the form of a system bus or some other connection mechanism.

In some embodiments, the computing device may also include one or more local knowledge base(s) 340. In some embodiments, the contents of the local knowledge base 340 for an individual interactive video is the same as the contents of the knowledge base 240 (FIG. 2) for the individual interactive video at the computing platform 200 of the back-end platform 104. In other embodiments, the local knowledge base 340 for the individual interactive video comprises a subset of the contents of the knowledge base 240 (FIG. 2) for the individual interactive video at the computing platform 200 of the back-end platform 104.

For example, in some instances, some (or perhaps all) of the prepared responses to expected questions for an interactive video may be downloaded to a local knowledge base 340 on an end-user computing device 106 when a viewer begins watching the interactive video on the end-user computing device 106. Downloading and storing at least some of the prepared responses to expected questions to a local knowledge base 340 at the end-user computing device 106 can enable the end-user computing device 106 to provide responses to questions more quickly than if the end-user computer device 106 had to obtain a response from the knowledge base 240 of the computing platform 200 of the back-end platform 104 after receiving a question from the viewer.

In line with the discussion above, the computing device 300 may take various forms, examples of which may include a wearable device, a laptop, a netbook, a tablet, a smart television, a smart speaker, and/or a smartphone, among other possibilities.

The processor 302 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed.

In turn, the data storage 304 may comprise one or more tangible, non-transitory computer-readable storage mediums, examples of which may include volatile storage mediums such as random-access memory (RAM), registers, cache, etc. and non-volatile storage mediums such as read-only memory (ROM), a hard-disk drive, a solid-state drive, flash memory, an optical-storage device, etc.

As shown in FIG. 3, the data storage 304 may be provisioned with software components that enable the computing device 300 to carry out authoring and/or rendering functions disclosed herein. For example, in some embodiments, the data storage 304 stores program instructions that, when executed by the one or more processors 302, cause the computing device 300 to perform one or more of the functions relating to one or more (or all) of (i) playing interactive video content, (ii) receiving or otherwise detecting a question posed by a viewer of the interactive video content, (iii) determining or otherwise obtaining a response to the posed question, and (iv) playing the response to the viewer.

Generally speaking, the software components described above may generally take the form of program instructions that are executable by the processor 302 to carry out the disclosed functions, which may be arranged together into software applications, virtual machines, software development kits, toolsets, or the like. Further, the data storage 304 may be arranged to store data in one or more databases, file systems, or the like. The data storage 304 may take other forms and/or store data in other manners as well.

The communication interface 306 may be configured to facilitate wireless and/or wired communication with another network-enabled system or device, such as the back-end platform 104, the authoring computing device 102, or the end-user computing device 106. The communication interface 306 may take any suitable form, examples of which may include an Ethernet interface, a serial bus interface (e.g., Firewire, USB 3.0, etc.), a chipset and antenna adapted to facilitate wireless communication, and/or any other interface that provides for wireless and/or wired communication. The communication interface 306 may also include multiple communication interfaces of different types. Other configurations are possible as well.

The user interface 308 may be configured to facilitate user interaction with the computing device 300 and may also be configured to facilitate causing the computing device 300 to perform an operation in response to user interaction. Examples of the user interface 308 include a touch-sensitive interface, mechanical interface (e.g., levers, buttons, wheels, dials, keyboards, etc.), and other input interfaces (e.g., microphones), among other examples. In some cases, the user interface 308 may include or provide connectivity to output components, such as display screens, speakers, headphone jacks, and the like.

The camera(s) 310 may be configured to capture a real-world environment in the form of image data and may take various forms. As one example, the camera 310 may be forward-facing to capture at least a portion of the real-world environment perceived by a user. One of ordinary skill in the art will appreciate that the camera 310 may take various other forms as well.

The sensors 312 may be generally configured to capture various data. As one example, the sensors 312 may comprise a microphone capable of detecting sound signals and converting them into electrical signals that can be captured via the computing device 300. As another examples, the sensors 312 may comprise sensors (e.g., accelerometer, gyroscope, and/or GPS, etc.) capable of capturing a position and/or orientation of the computing device 300, and such sensor data may be used to determine the position and/or orientation of the computing device 300.

Although not shown, the computing device 300 may additionally include one or more interfaces that provide connectivity with external user-interface equipment (sometimes referred to as “peripherals”), such as a keyboard, a mouse or trackpad, a display screen, a touch-sensitive interface, a stylus, speakers, microphones, etc., which may allow for direct user interaction with AR-enabled the computing device 300.

It should be understood that the computing device 300 is one example of a computing device that may be used with the embodiments described herein. Numerous other arrangements are possible and contemplated herein. For instance, other computing devices may include additional components not pictured and/or more or fewer of the pictured components.

### IV. Example Operations

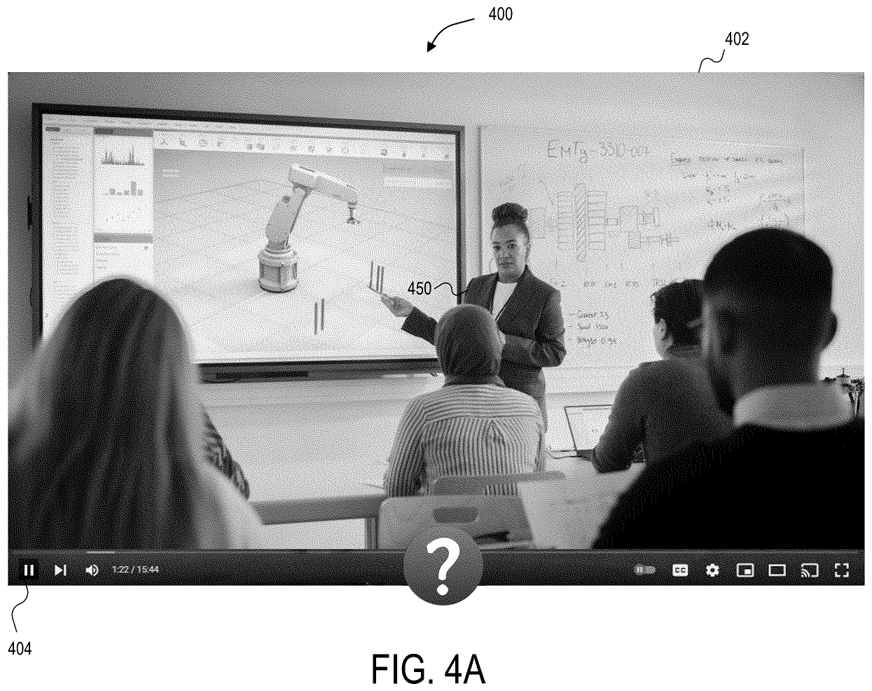

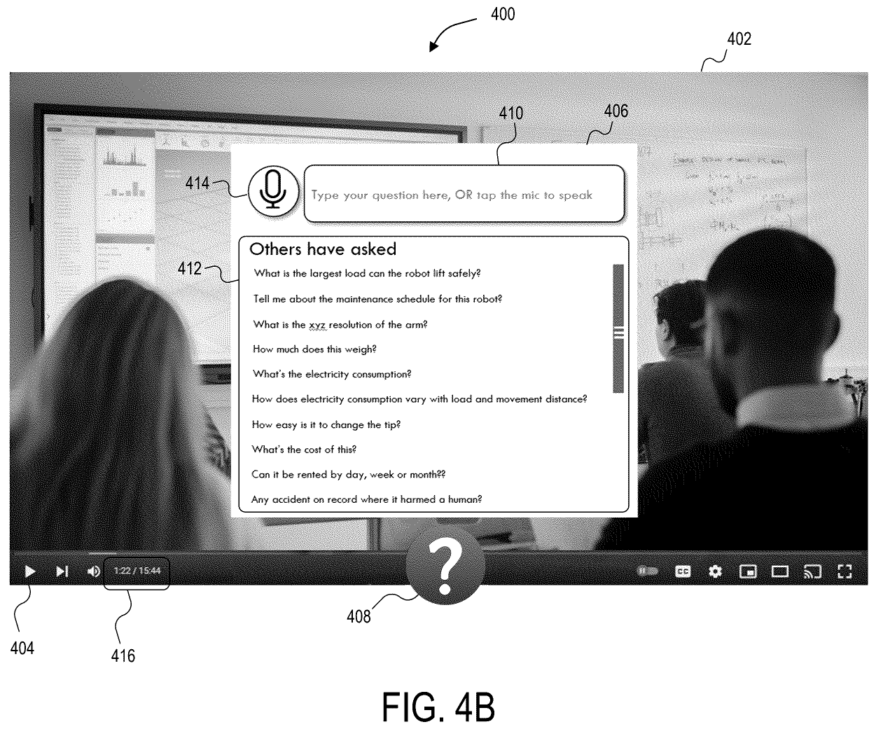

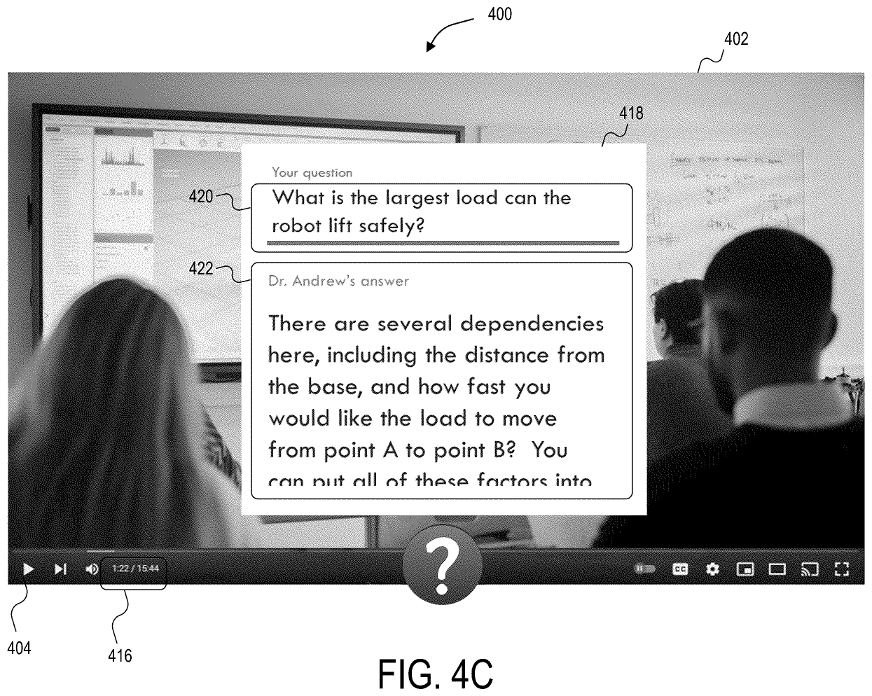

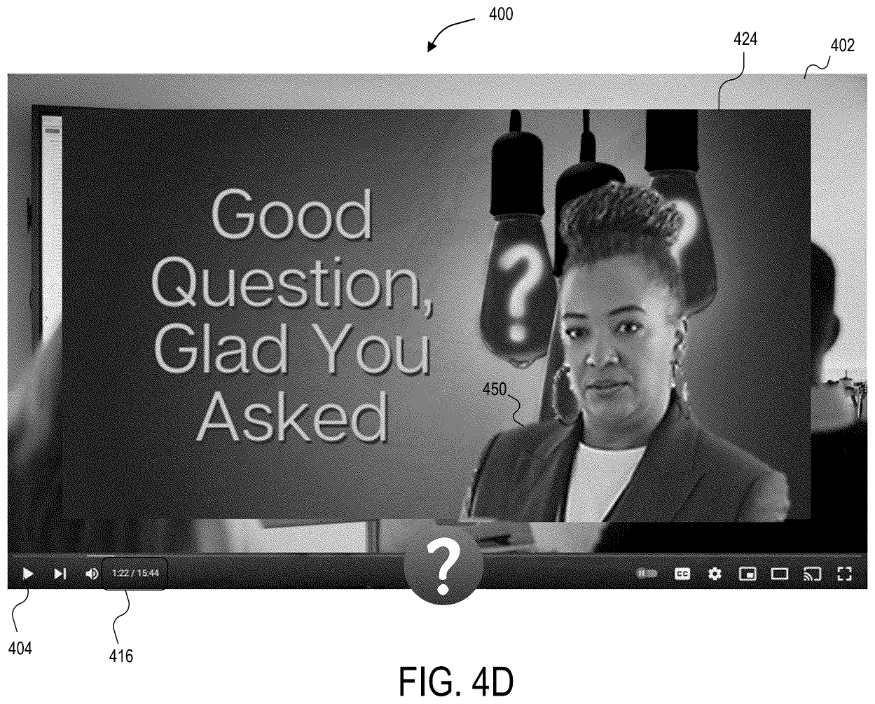

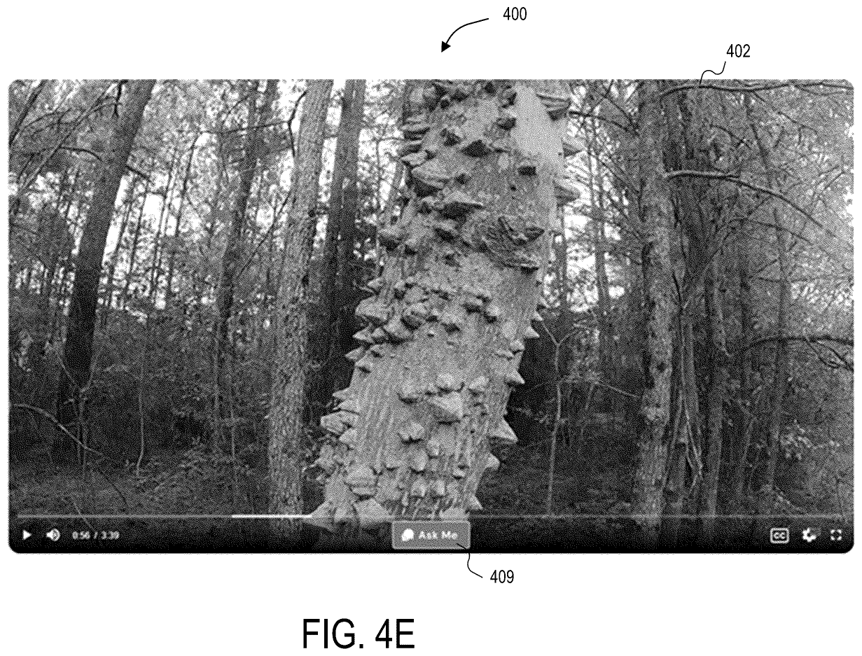

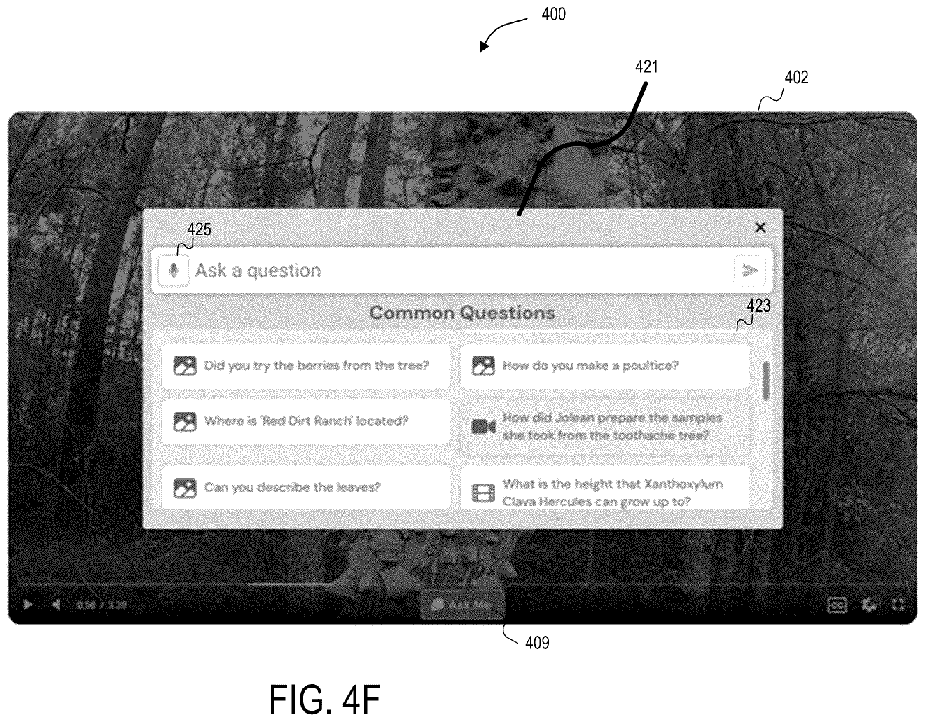

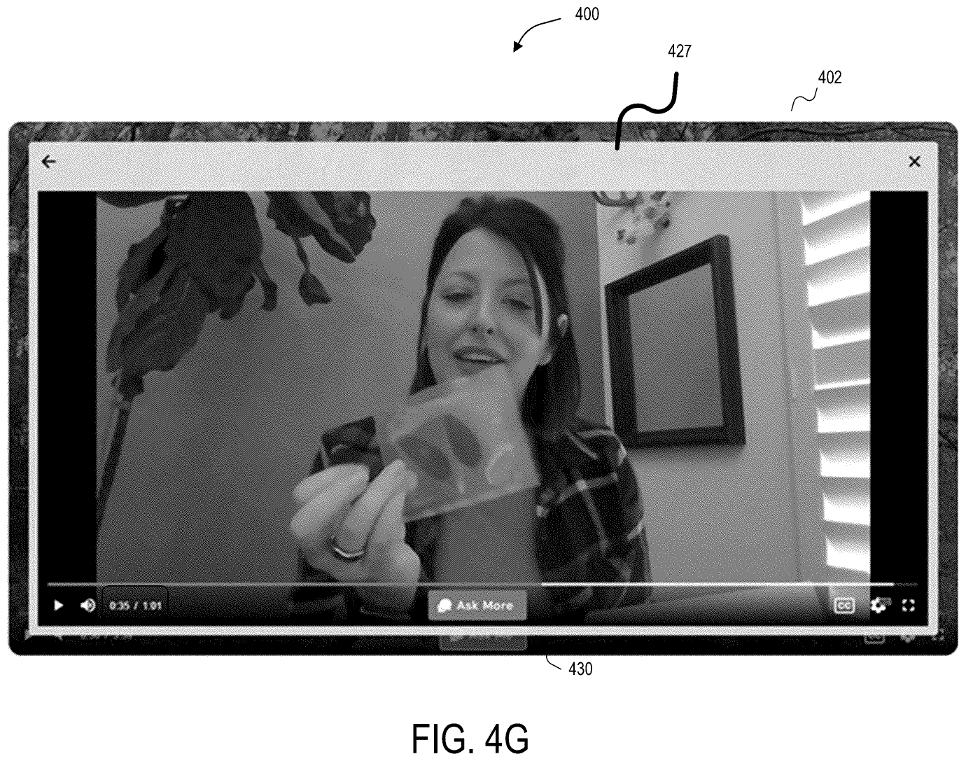

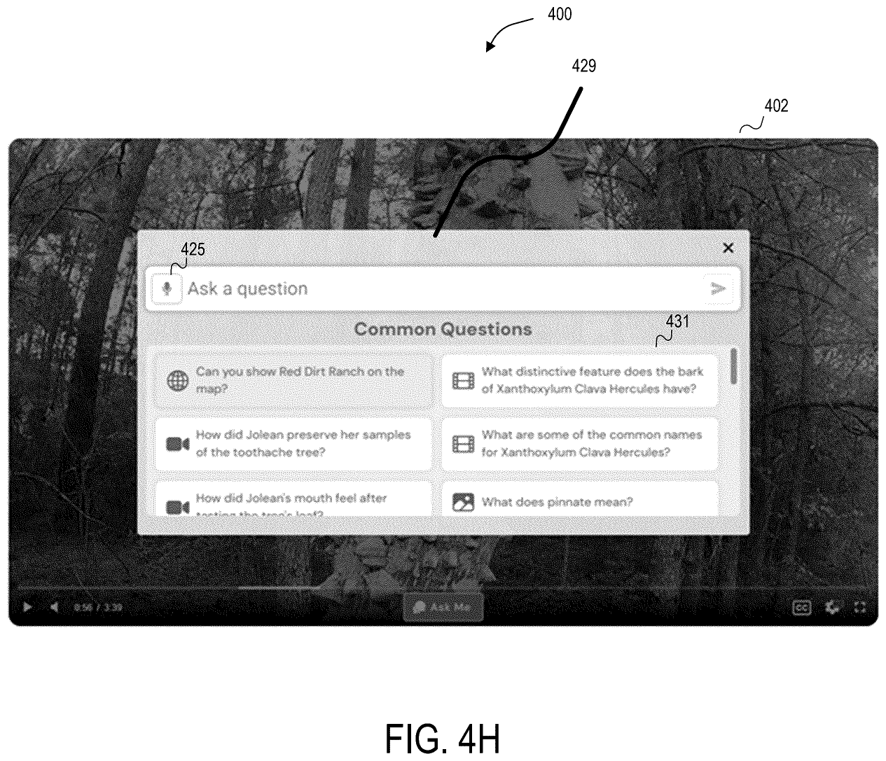

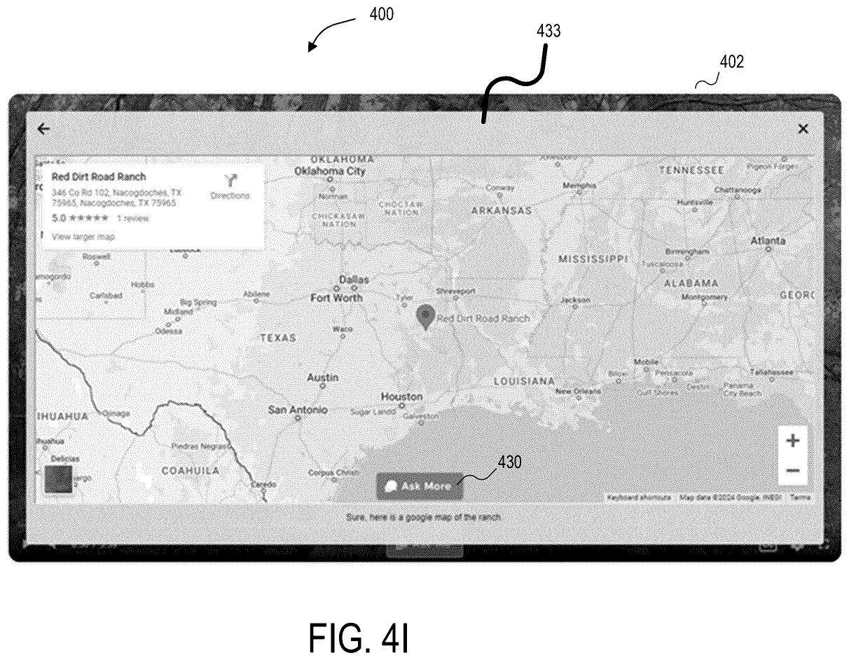

FIG. 4A shows an example of an interactive video 400 being played within an interactive video playback Graphical User Interface (GUI) 402 according to some embodiments. Typically, the interactive video 400 is played at a computing device such as the end-user computer device 106 (FIG. 3), which may be the same as or similar to computing device 300 (FIG. 3).

The interactive video 400 played within the interactive video playback GUI 402 in the example shown in FIG. 4A includes a speaking character 450. In this example, the speaking character 450 is a professor named Dr. Andrew (as explained further below) who can be seen in the interactive video 400. In other examples, the speaking character may not be visible in the interactive video 400, such as an interactive video that has a narrator or voice-over speaker who is heard but not seen in the interactive video. In still further examples, the speaking character may be an illustrated, animated, or computer-generated character, e.g., a digital character as described herein. Additional details about and examples of digital characters are contained in U.S. application Ser. No. 18/322,134, titled “Digital Character Interactions with Media Items in a Conversational Session,” filed on May 23, 2023, the entire contents of which are incorporated herein by reference.

The interactive video playback GUI 402 includes a control icon 404 that enables the viewer to start and stop/pause playback of the interactive video 400. In the example shown in FIGS. 4A-4D, when the interactive video 400 is playing, the control icon 404 appears as a “pause” symbol (two parallel lines) to indicate that selecting the control icon 404 will pause playback of the interactive video 400. And when the interactive video 400 is paused, the control icon 404 changes from the “pause” symbol to a “play” symbol (a triangle) to indicate that selecting the control icon 404 will restart playback of the interactive video 400. In addition to viewer control of the playback of the interactive video 400, aspects of playback of the interactive video 400 are also controlled by the back-end platform 104 (FIG. 1) implemented in some examples as computing platform 200 (FIG. 2), individually or in combination with the viewer's end-user device 106 (FIG. 1) implemented in some examples as computing device 300 (FIG. 3).

FIG. 4B shows an example of an input window 406 via which a viewer of the interactive video 400 depicted in FIG. 4A can pose a question according to some embodiments.

For example, while the interactive video 400 is playing within the interactive video playback GUI 402, a viewer can pose a question within the input window 406 by selecting/activating question icon 408 to launch question input window 406. In some embodiments, the question icon 408 may include text, e.g., “Ask Me” or similar, as shown and described further herein with reference to FIGS. 4E-4I.

In some embodiments, a viewer can pose a question by additionally or alternatively just asking a question without first selecting/activating the question icon 408 to launch the question input window 406. In such embodiments, the end-user computing device can be configured to use a microphone to listen for a question posed by the viewer. For example, the viewer may say, “I have a question” or simply just ask the question directly, e.g., “Will the unit still operate if I disconnect the temperature sensor?”

When the question input window 406 is launched in response to activation of the question icon 408, playback of the interactive video 400 is paused by the viewer's end-user device 106 (FIG. 1), individually or in combination with the back-end platform 104 (FIG. 1). As described previously with reference to FIG. 4A, when the interactive video 400 is paused, the control icon 404 changes from the “pause” symbol to the “play” symbol (a triangle) to indicate that selecting the control icon 404 will restart playback of the interactive video 400. In the example shown in FIG. 4B, playback of the interactive video 400 has been paused at 1:22 minutes into the interactive video 400, as shown by the “1:22/15:44” indication in box 416, and the control icon 404 has changed from the “pause” symbol (as shown in FIG. 4A) to the “play” symbol (shown in FIG. 4B).

The viewer can pose the question via any of several different ways. For example, the viewer can type the question into question entry box 410 within the question input window 406. Alternatively, the viewer can select a question from a list of prepared questions in box 412 within the question input window 406. Or the viewer can speak the question by selecting the microphone icon 414 within the question input window 406.

Regardless of how the viewer enters the question (e.g., typed input, selection from the list, or spoken), the computing device that is playing the interactive video 400 (e.g., computing device 300 (FIG. 3)) receives the viewer's question. In some embodiments, the computing device that is playing the interactive video 400 processes the question locally at the computing device. In some embodiments, the computing that is playing the interactive video 400 sends the question to a cloud system for processing. As explained previously, the cloud system may include one or more computing systems such as computing platform 200 (FIG. 2) of back-end platform 104 (FIG. 1). In embodiments where the computing device that is playing the interactive video 400 transmits the question to the cloud system (e.g., back-end platform 104) for processing, the cloud system also receives the question, but via the viewer's computing device.

After receiving the viewer question, a response to the viewer question is determined. The response to the question may be determined by one or both of the computing devices playing the interactive video 400 (e.g., computing device 300) or the cloud system (e.g., computing platform 200), individually or in combination with each other.

In some embodiments, determining the response to the viewer question includes selecting a response to the question from a knowledge base comprising pre-configured (and/or pre-generated) responses, where the selection is based on a natural language processing of the viewer's question. For example, determining the response to the viewer question may comprise looking up the viewer question (or perhaps keywords and/or phrases extracted from the viewer question based on the natural language processing of the question) in a local knowledge base at the computing device, such as knowledge base 340 of computing device 300 (FIG. 3). In some embodiments, determining the response to the viewer question may include using a machine learning classifier to classify the viewer's question based on how similar the viewer's question is to one of the pre-configured questions, and then selecting a response to the viewer's question that is associated with the pre-configured question that is most-similar to the viewer's question.

In some embodiments, determining a response to the viewer question may comprise obtaining a response from the cloud system. In some such embodiments, obtaining the response from the cloud system may comprise the cloud system looking up the viewer question (or perhaps keywords and/or phrases extracted from the viewer question based on the natural language processing of the question) in a knowledge base at the cloud system, such as knowledge base 240 of computing platform 200 (FIG. 2). Similarly, in some instances, the cloud system may be configured to use a machine learning classifier to determine how similar the viewer's question is to one of the pre-configured questions, and then select a response to the viewer's question, where the selected response is associated with the pre-configured question that is most similar to the viewer's question.

In some instances, a keyword/phrase-based lookup may return several potential responses. In some such instances, additional information may be used to help select one of the several potential responses.

For example, as described above with reference to the conversation analysis component 210 of the computing platform 200 (FIG. 2), the Sentiment Analysis Engine (SAE) 214 may analyze the text of the viewer's question, the tone or cadence of the audio of the viewer's question (if the question was spoken), and/or video of the viewer posing the question (if video of the viewer was captured) to infer additional information about the viewer, beyond the literal meaning of the question posed by viewer, such as the viewer's sentiment. For example, in some implementations, the viewer's voice fluctuations, tone, pauses, use of filler words, and/or use of corrective statements can be used to identify levels of stress, discomfort, or confusion. So, if the SAE 214 determines that the viewer seems confused, then of the several potential responses, the more detailed response may be selected for presentation to the viewer. Alternatively, if the SAE 214 determines that the viewer seems to understand the subject matter, then of the several potential responses, a less detailed response may be selected for presentation to the viewer.

Similarly, as explained above, the video processor 218 of the conversation analysis component 210 of the computing platform 200 may employ various machine learning methods, such as convolutional neural networks, recurrent neural networks, and/or capsule networks, to analyze video segments and/or captured images to identify features that can be used to analyze the viewer's body language. If the video processor 218 determines that the viewer is getting impatient, then of the several potential responses, a shorter response may be selected for presentation to the viewer. Alternatively, if the video processor 218 determines that the viewer seems very engaged and curious, then of the several potential responses, a more detailed response may be selected for presentation to the viewer.

In this manner, in addition to the text of the viewer's question, additional information can be inferred and used to help determine an appropriate response to the viewer's question.

In some embodiments, determining the response may additionally or alternatively include generating a natural language response (in “real time”) to the viewer's question using a generative model trained with a dataset comprising data corresponding to interactive video. In some embodiments, the generative model comprises a Generative Pre-trained Transformer (GPT) model. However, any other generative model now known or later developed that is suitable for generating natural language responses to viewer questions.

As explained above with reference to FIG. 2, the data corresponding to the interactive video that is used to train the generative model may comprise data from several sources. For example, in some embodiments, the training data used to train the generative model may include any one or more (or all) of: (i) a text transcription of the audio data of the interactive video; (ii) a text summary of the audio data of the interactive video; (iii) a text summary of the video data of the interactive video; (iv) data provided by a creator of the interactive video, such as questions and responses prepared by the content creator, including (a) pre-recorded video responses to expected questions relating to the interactive video, (b) prepared text-based responses to expected questions relating to the interactive video, and/or (c) prepared voice responses to expected questions relating to the interactive video; (v) text-based content corresponding to the interactive video; (vi) one or more presentations or other documents associated with to the interactive video; (vii) one or more Uniform Resource Locators (URLs) pointing to information related to the interactive video; (viii) data obtained from Internet searches of keywords extracted from one or both of the text transcription of the audio data of the interactive video and/or the data provided by the creator of the interactive video; (ix) text from viewer comments relating to the interactive video; (x) prior questions received from viewers of the interactive video; (xi) prior responses provided by the computing system to prior questions received from viewers of the interactive video; and/or (xv) pre-generated questions and/or pre-generated responses that have been previously generated by the generative model.

FIG. 4C shows an example of a text response 418 to the question posed by the viewer via the window 406 depicted in FIG. 4B according to some embodiments. In operation, playback of the interactive video 400 remains paused at 1:22 minutes into the interactive video 400 while the response 418 is displayed to the viewer, as shown by the “1:22/15:44” indication in box 416, and the control icon 404 indicating the “play” symbol.

In the example shown in FIG. 4C, the text response 418 includes (i) confirmation of the viewer question shown in box 420 and (ii) the content of the text response shown in box 422. The window containing the text response 418 is overlaid within the interactive video GUI 402. The text response 418 in the example shown in FIG. 4C is not displayed to the side of interactive video GUI 402, within a separate web browser page, within a separate text reader application window, etc. The text response 418 is presented in a box overlaid within the interactive video GUI 402. In some instances, the box overlaid within the interactive video GUI 402 is referred to herein as an experience window.

For example, even if the content of a response is from a separate document (e.g., a PDF, MS-Word, or other document), from a webpage (e.g., a website, Google maps, or other webpage), from another segment of interactive video (either a past segment or an upcoming segment), or from any of the generative models described herein, the response is presented in a box overlaid within the interactive video GUI 402 (e.g., an experience window) rather than within a separate window or a separate application.

In this example, the content of the text response in box 422 describes the text response 418 as “Dr. Andrew's answer.” In some embodiments, the content in box 422 is (or at least contains) text that was prepared by the content creator ahead of time (or perhaps previously generated), stored in the knowledge base, and associated with one or both of (i) the question in box 420, and/or (ii) one or more keywords and/or key phrases that match (or are similar to) one or more keywords and/or key phrases extracted from the question in box 420. In other embodiments, the content in box 422 is (or at least contains) content generated in “real time” by the generative model (e.g., a GPT or other suitable model) trained on data stored in the knowledge base associated with the interactive video 400.

In embodiments where the response 418 includes a text answer like the one shown in box 422, displaying the response 418 to the viewer additionally includes scrolling the text within the box 422 so that the viewer can read the full text of the answer. In some examples, displaying the response 418 to the viewer additionally includes audio of Dr. Andrew (or another speaker) reading the text of the answer in box 422 while the text of the answer is scrolled within the box 422. Some embodiments may include playing audio of Dr. Andrew reading the text of the answer in box 422 without showing the text of the answer in box 422. For example, in some embodiments where the response is only an audio response, playing the response may not necessarily include displaying a window within the GUI.

In some examples where displaying or otherwise providing the response 418 to the viewer includes playing audio of Dr. Andrew reading the text of the answer, the audio may be either (i) pre-recorded audio of Dr. Andrew reading the text of the answer or (ii) a simulation of Dr. Andrew's voice reading the text of the answer. For example, some embodiments include “cloning” Dr. Andrew's voice based on the audio of Dr. Andrew in the interactive video 400. Voice cloning can be performed using technology from any of several companies, including but not limited to Eleven Labs, Inc., available at https://elevenlabs.io/. In embodiments that use voice cloning, the text of the response can be read in the voice of (i) a speaking character shown in the interactive video 400, e.g., Dr. Andrew in this example, (ii) a speaking character not shown in the interactive video 400, e.g., the voice of a narrator in the video, or (iii) most any other voice desired by either the content creator or even the viewer.

FIG. 4D shows an example of a video response 424 to the question posed by the viewer via the window 406 depicted in FIG. 4B according to some embodiments.

In operation, playback of the interactive video 400 remains paused at 1:22 minutes into the interactive video 400, as shown by the “1:22/15:44” indication in box 416, and the control icon 404 indicating the “play” symbol.

In the example shown in FIG. 4D, the video response 424 includes Dr. Andrew explaining an answer to the question posed by the viewer via the window 406 in FIG. 4B.

In some embodiments, the video response 424 includes video that was prepared ahead of time by the content creator, stored in the knowledge base, and associated with one or both of (i) the question in box 420 (FIG. 4C), and/or (ii) one or more keywords and/or key phrases that match (or are similar to) one or more keywords and/or key phrases extracted from the question in box 420 (FIG. 4C). In other embodiments, the video response 424 is (or at least contains) content generated in advance by the generative model (e.g., a GPT or other suitable model) trained on data stored in the knowledge base associated with the interactive video 400, stored in the knowledge base, and associated with one or both of (i) the question in box 420 (FIG. 4C), and/or (ii) one or more keywords and/or key phrases that match (or are similar to) one or more keywords and/or key phrases extracted from the question in box 420 (FIG. 4C). And in other embodiments, the video response 424 includes content generated in “real time” by the generative model (e.g., a GPT or other suitable model) trained on data stored in the knowledge base associated with the interactive video 400.

In some examples, the video response 424 may include video of a computer-generated character (sometimes referred to as a digital character) or a computer-generated simulation of a speaking character from the interactive video 400, e.g., Dr. Andrew 450. For example, if an appropriate pre-recorded (or pre-generated) video response is available, that pre-recorded (or pre-generated) video response can be selected from a library of video responses and played to the viewer. But if a text-based answer would be more appropriate than one of the pre-recorded (or pre-generated) video responses, the text of the text-based answer can be used as a script for either (i) a simulation of the speaking character (e.g., Dr. Andrew in this example) or (ii) another digital character.

Further, in some embodiments, the text of an answer to the question in box 420 (FIG. 4C) can be generated by a generative model in “real time” and used as a script for a computer-generated character in the video response 424.

FIG. 4E shows an example of an interactive video 400 with an “Ask Me” button 409 at the bottom of the interactive video playback GUI 402 according to some embodiments.

The “Ask Me” button 409 at the bottom of the interactive video playback GUI 402 in FIG. 4E performs the same function as the question icon 408 shown in FIGS. 4A-D and described in detail with reference to FIG. 4B. In some examples, the “Ask Me” button 409 can be customized for a particular interactive video. For instance, with reference to FIGS. 4A-D, the “Ask Me” button could be customized to say “Ask Dr. Andrew.” Similarly, if the video is a product marketing video produced by SalesCo, Inc., the “Ask Me” button could be customized to say “Ask SalesCo, Inc.” or “Ask SalesCo” or similar.

FIG. 4F shows an example of an “Ask a Question” window 421 launched within the interactive video playback window GUI 402 in response to activation of the “Ask Me” button 409 depicted in FIG. 4E according to some embodiments. The “Ask a Question” window 421 is overlaid within the interactive video playback GUI 402 (e.g., within an experience window) rather than appearing in a separate chat window, a separate application, or a separate website, etc.

The “Ask a Question” window 421 in FIG. 4F performs the same function or a similar function as the question entry box 410 shown and described in detail with reference to FIG. 4B. For example, the viewer can pose the question via the “Ask a Question” window 421 in any of several different ways. For example, the viewer can type the question into the “Ask a Question” window 421. Alternatively, the viewer can select a question from a set of Common Questions 423 presented within the “Ask a Question” window 421, similar to the list of prepared questions in box 412 shown in FIG. 4B. Or the viewer can speak the question by selecting the microphone icon 425 within the “Ask a Question” window 421.

From the standpoint of authoring interactive video content, the question icon 408 (FIGS. 4A-4D), “Ask Me” button 409 (FIGS. 4E-F), and/or the “Ask More” button 430 (FIGS. 4F and 4I) can be implemented with information and/or functionality obtained from any suitable content source available to the system.

For example, any one or more (or all) of the question icon 408, “Ask Me” button 409, and/or “Ask More” button 430 can be connected to any one or more (or all) of knowledge base(s) 240 (FIG. 2), knowledge base(s) 340 (FIG. 3), any of the generative models disclosed herein (including Internet-accessible generative models) to provide and/or generate responses.

In some examples, regardless of where a particular response may have been obtained, the response is translated into the viewer's preferred language. For instance, if a response is in English but the viewer prefers Spanish, then some embodiments include translating the English language response into Spanish. Such translation can be performed regardless of the form of the response. For instance, an English language text response can be translated into Spanish, an English language document included with a response can be translated into Spanish, an English language video included with a response can be translated into Spanish, and so on.

In some examples, responses generated in response to questions posed by a viewer may include dynamic calculations based on input provided by the viewer.

For example, if the interactive video is a video for selling or marketing a piece of real estate, the viewer can activate an “Ask Me” button to ask what the monthly payments might be for different mortgage rates, payment terms, down payments, commissions, etc. And the response can include an answer by using appropriate calculations (e.g., using one or more formulas provided by the author) to generate answers based on the viewer's inputs. Some such examples may additionally or alternatively include launching a mortgage calculator in an overlay window within the interactive video GUI 402.

In another example, for an educational interactive video, the viewer may ask the teacher to solve a problem similar to one that is solved in the interactive video, but with different numbers provided by the viewer. And the response can include an answer by using appropriate calculations (e.g., using one or more formulas provided by the author) to generate answers based on the viewer's inputs (i.e., the different numbers provided by the viewer).

Further, from an interactive video authoring standpoint, the question icon 408, “Ask Me” button 409, and/or “Ask More” button 430 can be placed anywhere within the interactive video GUI 402. For example, the question icon 408, “Ask Me” button 409, and/or “Ask More” button 430 can be placed at the bottom of the interactive video window, within a video response window, within a text response window, within a particular scene or segment of the interactive video, on or adjacent to an item depicted within the interactive video.

And in response to activating any of the question icon 408, “Ask Me” button 409, and/or “Ask More” button 430, an experience window is displayed close to the question icon 408, “Ask Me” button 409, and/or “Ask More” button 430, such as input window 406 (FIG. 4B), video response 424 (FIG. 4D), “Ask a Question” window 421 (FIG. 4F), video response 427 (FIG. 4G), “Ask a Question” window 429 (FIG. 4H), interactive map 433 (FIG. 4I). Some embodiments may include generating an experience window at certain times or during certain segments of the interactive video even when the viewer has not asked a question, which can be useful for encouraging the viewer to interact with the interactive video.

One difference between the set of Common Questions 423 presented within the “Ask a Question” window 421 shown in FIG. 4F and the list of prepared questions in box 412 question entry box 410 shown in the FIG. 4B is that the individual questions within the set of Common Questions 423 include icons that give the viewer information about the form of the response to the question whereas the list of prepared questions in box 412 do not have similar icons describing the form of the response.

For example, the three questions on the left side and the top question on the right side of the set of Common Questions 423 each include a photo icon, which indicates that the response to the question includes a photograph. The second question from the top on the right side of the set of Common Questions 423 includes a video camera icon, which indicates that the response to the question includes a video response. The third question from the top on the right side of the set of Common Questions 423 includes a video clip icon, which indicates that the response to the question includes a clip from the interactive video (e.g., a past segment or a future segment of the video).

Other examples exist, too. For instance, in some embodiments, the question may include a map icon (e.g., as shown in FIG. 4H), which indicates that the response includes a map (or even an interactive map). Similarly, in some embodiments, the question may include a music icon, which indicates that the response includes an audio track (e.g., a song, a spoken word track, or other audio track). And in still further embodiments, the question may include a document icon, which indicates that the response includes a document (e.g., a PDF document, an MS-Word document, a spreadsheet, or other type of document).

FIG. 4G shows an example of a video response 427 launched within the interactive video playback window of the GUI 402 in response to receiving a viewer selection of one of the “Common Questions” 423 in the “Ask a Question” window 421 depicted in FIG. 4F, such as the question stating, “How did Jolean prepare the samples she took from the toothache tree?” and includes the video icon. The video response 427 is overlaid within the interactive video playback GUI 402 rather than appearing in a separate chat window, a separate application, or a separate website, etc.

The video response 427 includes an “Ask More” button 430. The “Ask More” button 430 within the video response 427 depicted in FIG. 4G is similar to the “Ask Me” button 409 at the bottom of the interactive video playback GUI 402 in FIG. 4E. As the name implies, in some instances, the “Ask More” feature is implemented in scenarios where, for example, the viewer has previously activated an “Ask Me” feature and received a response. In some such scenarios, activating the “Ask More” feature enables the viewer to obtain further information about the response from the most recent “Ask Me” interaction.

FIG. 4H shows another example of an “Ask a Question” window 429 launched within the interactive video playback GUI 402 in response to activation of the “Ask Me” button depicted in FIG. 4E according to some embodiments. In some instances, the “Ask a Question” window 429 may be launched in response to activation of the “Ask More” button 430 depicted in FIG. 4G. Similar to the “Ask a Question” window 421 in FIG. 4E, the “Ask a Question” window 429 in FIG. 4H also includes the microphone icon 425 and a set of “Common Questions.” The set of “Common Questions” 431 in FIG. 4H is similar to the set of “Common Questions” 423 in FIG. 4E. For example, like the set of “Common Questions” 423 in FIG. 4E, each question in the set of “Common Questions” 431 in FIG. 4H also includes an icon that gives the viewer information about the form of the response to the question, such as a map icon (indicating the response includes a map), a video icon (indicating the response includes a video), a video clip icon (indicating the response includes another segment of the interactive video), a photo icon (indicating the response includes a photo), or any other icon indicating any other type of suitable response.

FIG. 4I shows an example of an interactive map 433 launched within the interactive video playback GUI 402 in response to receiving a viewer selection of one of the “Common Questions” 431 in the “Ask a Question” window 429 depicted in FIG. 4H, such as the top question of the left side of the “Common Questions” 431, which states, “Can you show Red Dirt Ranch on the map?” and includes a map icon. The interactive map 433 is overlaid within the interactive video playback GUI 402 rather than appearing in a separate window, a separate application, or a separate website, etc. Although the example interactive map 433 in FIG. 4I is from Google Maps, any suitable map from any suitable map software or map service could be used.

Similar to the video response 427 in FIG. 4G, the interactive map 433 also includes an “Ask More” button 430. The “Ask More” button 430 within the interactive map 433 depicted in FIG. 4I is similar to the “Ask Me” button 409 at the bottom of the interactive video playback GUI 402 in FIG. 4E.

FIGS. 4A-4I show example scenarios where a single viewer poses questions to and receives responses from the interactive video in a single-viewer mode. However, in other examples, multiple viewers can watch the interactive video at the same time in a multi-viewer mode. Many aspects of interactive video systems and methods are the same in the multi-viewer mode as in the single-viewer mode. However, the multi-viewer mode introduces several new features.

For example, the computing system may be configured to pause playback of the interactive video upon detection of a question in multi-viewer mode differently than when in single-viewer mode. In some embodiments, when the computing system detects that a first viewer has a question (e.g., detects activation of question icon 408 (FIG. 4B) on the first viewer's end-user computer device or detects that the user has verbalized a question perhaps without first activating the question icon 408), the computing system is configured to capture the question posed by the first viewer.

In some embodiments, the computing system pauses playback of the interactive video for all of the viewers upon detecting activation of the question icon 408 (FIG. 4B) at the first viewer's end-user computing device. In other embodiments, however, rather than pausing playback of the interactive video for all of the viewers upon detecting activation of the question icon 408 (FIG. 4B) at the first viewer's end-user computing device, the computing system instead sends an indication to the other viewers that the first viewer (or at least some viewer other than them) has posed a question while continuing to play the interactive video for the other viewers.

This is similar to when one student in a classroom raises his or hand while the teacher is speaking. Just like the teacher and the other students see the raised hand, the computing system and the other viewers know that the first viewer has a question. However, unlike the classroom analogy, the other viewers do not see or hear the first user's question or the response thereto until there is a natural break in the video, such as at the end of segment, chapter, module, break point, or other stopping point. At that time, the first viewer's question is shared with the other viewers.

In some embodiments, each viewer can then decide if he or she wishes to hear the response to the first viewer's question. And then the computing system causes playback of the response at the end-user computing devices of all of the other viewers who chose to hear the response. In operation, the responses played in the multi-viewer mode are the same (or at least substantially the same) as the responses that are played in the single-viewer mode. In some instances, during the break, one or more viewers can additionally choose to view supplemental content relating to the interactive video and/or the response to the first viewer's question. However, each of the one or more other viewers choosing to view supplemental content may view the supplemental content in a single-viewer arrangement where the computing system causes playback of the selected supplemental content only at the viewer's end-user computing device who chose to view that selected supplemental content.

Any viewer who chooses not to hear the response to the first viewer's question at the stopping point when the first viewer's question is shared with other viewers in the multi-viewer session can decline to hear the response, and thus, the computing system will not cause that viewer's end-user computing device to play the response to the first viewer's question.

In some instances, the computing system alerts each of the viewers in the multi-viewer session when the break period is about to end and playback of the interactive video will be restarted. At that time, each viewer can choose to rejoin the multi-viewer session for the next chapter/section/module/etc. or proceed individually in a single-viewer fashion.

Some multi-viewer embodiments may resemble a classroom environment. For example, in some multi-viewer embodiments, playback of the interactive video is paused when any viewer poses a question similar to how a teacher may pause a lecture when a student raises a hand to ask a question. However, to prevent one viewer's actions from adversely affecting all of the other viewers' experience, some multi-viewer embodiments may limit each viewer to some maximum number of questions during a particular interactive video session. For example, once a viewer reaches the maximum number of allotted questions, the system may (i) prevent that viewer from asking another question during the multi-viewer session and/or (ii) transition that viewer from the multi-viewer session into his or her own single-viewer session. In some scenarios, multiple viewers may be transitioned to their own individual interactive single-viewer sessions or possibly their own sub-group multi-viewer session.

Some multi-viewer embodiments may additionally or alternatively require some consensus among the viewers to pause the interactive video and play a response. For example, when a first viewer asks a question, the first viewer's question is shared with other viewers. If enough of the other viewers (e.g., more than about 30-50% of the viewers, more than some raw number of viewers, etc.) would like to hear an answer to the first question, then playback of the interactive video is paused while the response/answer is played in the multi-viewer session (i.e., the response/answer is played on all of the end user computing devices participating in the multi-viewer session). In some instances, consensus may be reached before (or without) sharing the first viewer's question.

Some embodiments may additionally include a social feature relating to the interactive video. In the social feature, the computing system lists questions asked and/or chat topics discussed by viewers while watching the interactive video.

In some instances, the questions asked and/or chat topics may be generated by a generative model based on a set of questions asked and/or chat topics discussed. For example, the questions asked, the transcript of the video (or portions thereof), and chat logs can be provided to a text summarization model comprising a large language model (LLM) configure to perform natural language processing (NLP) of the data set and generate a summary of questions and chat topics.

In some embodiments, the questions and chat topics are displayed within the GUI, for example, overlaid on top of the interactive video and/or listed in a sidebar next to the window in which the interactive video is being played. In some instances, the questions and/or discussion topics are associated with timestamps during playback of the interactive video. And when playback of the interactive video reaches a timestamp or general timeframe associated with one or more questions and/or chat topics, the one or more questions and/or chat topics associated with that timestamp or general timeframe are displayed to the viewer. Displaying questions and/or chat topics for the viewer to select during playback of the interactive video at relevant times during playback may help viewers leverage the history of asked questions and/or chat topics to understand the subject matter of the interactive video more quickly. Additionally, knowing the questions asked and chat topics discussed at different times during playback of the interactive video can also help the content creator improve both the base video and the interactive content associated with the base video.

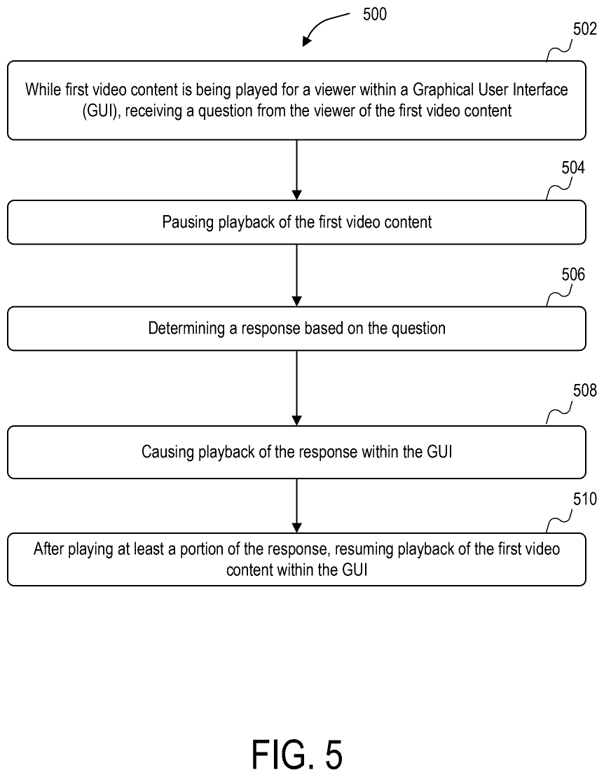

FIG. 5 shows an example method 500 for implementing interactive video according to some embodiments. Method 500 may be performed by any one or more computer devices or systems, individually or in combination with each other. For example, in some embodiments, an end-user computing device 106 (FIG. 1) such as computing device 300 (FIG. 3) may perform one or more (or all) of the method 500 functions. In other embodiments, a cloud system or back-end platform 104 (FIG. 1) such as computing platform 200 (FIG. 2) may perform or more (or all) of the method 500 functions. In still further embodiments, an end-user computing device may perform some of the method 500 functions while a cloud system or back-end platform may perform other method 500 functions. Thus, in operation, a computing system configured to perform method 500 may include one or both of an end-user computing device and/or a back-end platform.

Method 500 begins at method block 502, which includes while first video content is being played for a viewer within a Graphical User Interface (GUI), receiving a question from the viewer of the first video content. In some embodiments, the first video content includes video data and audio data.

In some embodiments, while first video content is being played for a viewer in method block 502, receiving a question from the viewer of the first video content in method block 502 includes causing the GUI to display a prompt to the viewer, where the GUI is configured to receive the question from the viewer. For example, in some instances, receiving the question from the viewer of the first video content at method block 502 includes receiving text corresponding to at least one of (i) a question typed by the viewer via the GUI, (ii) a speech-to-text translation of a question spoken by the viewer, or (iii) a question selected by the viewer from a set of questions presented within the GUI. However, in some embodiments, and as described above, receiving a question from a viewer of the first video content in method block 502 includes the computing system receiving a voice input comprising the question via one or more microphones of the viewer's end-user computing device without the viewer first activating any particular prompt that may (or may not) be displayed via any GUI.

Next, method 500 advances to method block 504, which includes pausing playback of the first video content. In some embodiments, it may be advantageous to pause playback of the first video content upon detecting that the viewer wishes to pose a question, for example, as shown and described with reference to FIG. 4B. In some embodiments, playback of the first video content may not be paused until the viewer has finished posing the question. In some embodiments, pausing the playback of the first video content at block 504 includes determining a natural place to stop/pause the video after receiving the viewer question at block 502. For example, a natural stopping place may be after the speaking character has finished speaking a sentence or after the speaking character has finished speaking a set of closely-related sentences. In embodiments where the text transcript of the video content is divided into paragraphs and/or other sections, pausing playback at block 504 may include pausing playback at the end of a paragraph and/or similar section.

In some multi-viewer embodiments, pausing playback of the first video content at block 504 may include pausing playback only if more than some threshold number of viewers in the multi-viewer session have reached consensus on pausing playback of the first video content. For example, as described above, if some minimum threshold of viewers reach consensus on pausing the video to hear the response to one viewer's question, then playback of the first video content is paused so that the response can be played (e.g., at block 508 described below). But if an insufficient number of viewers agree to pausing playback, then the viewer question may be held until the end of the multi-viewer session (or perhaps a scheduled break in the multi-viewer session). And then at the end of the multi-viewer session (or during the scheduled break), the response can be played (e.g., at block 508) to the viewer and one or more other viewers who elect to hear the response.

Next, method 500 advances to method block 506, which includes determining a response based on the question received at block 502.

In some instances the response at method block 506 is selected from a library of responses that have been prepared in advance by the content creator and/or generated in advance by a generative model as described in detail earlier. In some embodiments, a knowledge base contains the library of prepared (and/or pre-generated) responses, and the step of determining a response at method block 506 based on the question received at block 502 includes selecting the response from a knowledge base containing the library of prepared (and/or pre-generated) responses. In some embodiments, the knowledge base is the same as or similar to knowledge base 240 (FIG. 2), knowledge base 340 (FIG. 3), and/or any other knowledge base disclosed or described herein. In operation, the knowledge base containing the library of prepared (and/or pre-generated) responses is created and/or maintained according to any of the previously-described methods of generating and/or maintaining a knowledge base associated with interactive video.

For example, in some embodiments, the response determined at block 506 includes one or more of: (i) a pre-recorded (or pre-generated) video response associated with the question received at block 502; (ii) a prepared (or pre-generated) text-based response associated with the question received at block 502; (iii) a prepared (or pre-generated) voice response associated with the question at block 502; (iv) a presentation or other document associated with the question received at block 502; and/or (v) a Uniform Resource Locator (URLs) associated with the question from block 502 that points to information related to the question from block 502. As described previously, in some instances, the response may include a follow up question posed back to the viewer. In some examples, the follow up question may seek further information from the viewer to help refine or clarify the viewer's question, or perhaps to obtain information about the viewer's knowledge and/or experience. In such examples, the viewer's answer to the follow up question is used (perhaps in combination with the viewer's initial question that spawned the follow up question) to select a response to the viewer's initial question that has an appropriate level of detail for the viewer.

In some instances, the response at method block 506 is a response generated in “real time” using a generative model such as a Generative Pre-trained Transformer (GPT) model. However, other suitable generative models could be used as well (or instead). In some embodiments, the generative model is trained with a dataset comprising data corresponding to the first video content. As mentioned earlier, the first video content in some embodiments includes video data and audio data.

In such embodiments, the dataset comprising data corresponding to the first video that is used to train the generative model may include, any one or more (or all) of: (i) a text transcription of the audio data of the interactive video; (ii) a text summary of the audio data of the interactive video; (iii) a text summary of the video data of the interactive video; (iv) data provided by a creator of the interactive video, such as questions and responses prepared by the content creator, including (a) pre-recorded video responses to expected questions relating to the interactive video, (b) prepared text-based responses to expected questions relating to the interactive video, and/or (c) prepared voice responses to expected questions relating to the interactive video; (v) text-based content corresponding to the interactive video; (vi) one or more presentations or other documents associated with to the interactive video; (vii) one or more Uniform Resource Locators (URLs) pointing to information related to the interactive video; (viii) data obtained from Internet searches of keywords extracted from one or both of the text transcription of the audio data of the interactive video and/or the data provided by the creator of the interactive video; (ix) text from viewer comments relating to the interactive video; (x) prior questions received from viewers of the interactive video; (xi) prior responses provided by the computing system to prior questions received from viewers of the interactive video; and/or (xv) pre-generated questions and/or pre-generated responses that have been previously generated by the generative model.

Next, method 500 advances to method block 508, which includes causing playback of the response within the GUI. In some embodiments, causing playback of the response at method block 508 may additionally or alternatively include causing playback via means other than the GUI. For example, as described earlier, in embodiments where the response is only audio, the response may be played via one or more speakers while playback of the video is paused in the GUI. Further, and as described previously, playback of the response may include coordinating playback of the response via an end-user computing device that is different than the end-user computing device that is playing the video. Still further, and as explained earlier, playing of the response may additionally or alternatively include coordinating playback of the response via two or more end-user computing devices, including (i) scenarios where one of the two or more end-user computing devices is the end-user device configured to play the first video content and/or (ii) scenarios where neither of the two or more end-user computing devices is the end-user device configured to play the first video content.

In some embodiments, the response played at method block 508 includes one or more of (i) a text response displayed within the GUI, (ii) a voice response played within the GUI, (ii) second video content played within the GUI, (iii) a Uniform Resource Locator (URL) displayed within the GUI, wherein the URL contains a link to information relating to the question, or (iv) an electronic document displayed within the GUI.

In some embodiments where the first video content comprises a speaking character, the response played at method block 508 includes a voice response derived from a voice of the speaking character. In some instances, the speaking character includes one of (i) a speaking character shown in the first video content or (ii) a speaking character not shown in the first video content. In some examples, the voice used for the voice response is a clone of the speaking character's voice.

In some embodiments, the response played at method block 508 includes second video content selected from a library of pre-recorded and/or pre-generated video content.

In some embodiments where the first video content comprises a speaking character and the response played at method block 508 includes second video content selected from the library of pre-recorded and/or pre-generated video content, the second video content comprises video of the speaking character.

In some embodiments where the first video content comprises a speaking character and the response played at method block 508 includes second video content, the second video content comprises a computer-generated character, sometimes referred to herein as a digital character. In some instances, the computer-generated character is one of (i) a computer-generated version of the speaking character in the first video content or (ii) a computer-generated character different than the speaking character in the first video content.

In some embodiments, the response played at method block 508 includes a portion of the first video content. For example, if the first video content covers three topics and the viewer asks a question about the second topic during playback of the portion of the first video addressing the first topic, then the response played at method block 508 might include a portion of the first video addressing the second topic.

For example, after the viewer has posed a question at method block 502, the response provided from the computing system may take the viewer to another part of the interactive video that contains an answer to the viewer's question. In some instances, the viewer's question may even be an express request to go to the other part of the interactive video, such as, “Can you take me to where the presenter was talking about the air filter?”

But even if the question is not an explicit request to go to another part of the video (e.g., “How do you change the air filter?”), the response may include (i) a statement such as “Changing the air filter is covered later in this video. Let me take you there now.” and (ii) then playing the portion of the video that shows changing the air filter. Then, after playing the portion of the video that shows changing the air filter, playback of the video can be resumed at the point where the viewer asked the question about changing the air filter, for example in the manner described below with reference to method block 510.

In some instances where the response played at method block 508 includes (i) a voice response and (ii) a portion of the first video content, causing playback of the response at method block 508 includes causing playback of the voice response with the portion of the first video content.

In some embodiments, the response played at method block 508 includes a second question (e.g., a follow up question as described previously) that is responsive to the viewer question from method block 502. In some instances, the second question may ask the viewer to clarify one or more aspects of the viewer question from method block 502. In some embodiments where the response played at method block 508 includes a second question responsive to the viewer question from method block 502, method 500 additionally includes (i) receiving a second response from the viewer (i.e., the viewer's response), and (ii) determining a third response based on the viewer's response. In operation, determining the third response based on the viewer's response is similar to the method block 504 step of determining a response based on the viewer question from method block 502.

In some instances, causing playback of the response at method block 508 includes causing the response to play in at least one of (i) the same GUI window as the first video content, (ii) a smaller GUI window within the main GUI window playing first video content, or (iii) a second GUI window separate from the main GUI window playing the first video content, including but not limited to a second GUI window adjacent to the main GUI window. In some instances, the second GUI window adjacent to the main GUI window does not overlap or otherwise obscure any portion of the main GUI window, thereby enabling the viewer to see both the paused first video within the main GUI and the response in the second GUI window. In some embodiments, the main GUI window may be resized so that the second GUI window with the response can be displayed without obscuring any portion of the main GUI window. For example, as described previously, in some instances, playback of the response may be coordinated among two or more end-user computing devices.

For example, in some embodiments where the response played at method block 508 is a text response, causing playback of the response within a GUI at method block 506 may include displaying the text response in a smaller GUI window within the GUI window of the first video content. In another example where the response played at method block 508 comprises second video content, causing playback of the response within the GUI at method block 508 may include playing the second video content in the same GUI window as the first video content. In yet another example where the response played at method block 508 comprises a presentation, causing playback of the response within the GUI at method block 508 may include playing the presentation in a GUI window separate from the GUI window of the first video content.

Other combinations of response type (e.g., text, video, document) and display mode (e.g., same GUI window as the first video content, smaller GUI window within the GUI window of the first video content, and GUI window separate from the GUI window of the first video content) are contemplated, too. Further, in embodiments where the response played at method block 508 is an audio-only response, causing playback of the response at method block 508 may include playing the audio-only even without a separate GUI or any modification to the GUI window of the first video content.

Next, method 500 advances to method block 510, which includes after playing at least a portion of the response, resuming playback of the first video content within the GUI.

In some instances, resuming playback of the first video content within the GUI comprises resuming playback of the first video from a point in the first video content where the first video content was paused before causing playback of the response. In other instances, resuming playback of the first video content within the GUI comprises resuming playback of the first video from a point in the first video content that is different from the point in the first video content where the first content was paused before causing playback of the response.

Some embodiments may additionally include the computing system initiating feedback from the viewer during playback of the interactive video.

For example, in some instances, the computing system is configured to pause playback of the interactive video and pose one or more questions to the viewer to answer. In some examples, after identifying an appropriate stopping point during playback (e.g., at the end of a segment, chapter, module, or similar), the computing system may pose questions about the subject matter covered in the previous segment or chapter. The questions posed to the viewer may be provided by the content creator, or generated by the generative model based on the data contained within the knowledge base. In operation, the generative model generates questions to pose to viewers at the end of segments in substantially the same way that the generative model generates potential questions and responses described above. In some examples, in addition to or instead of posing questions to the viewer, the computing system may display keywords or topics as an overlay to the video so that the viewer can select the displayed keywords or topics to obtain further information. In some instances, the computing system can use the viewer's answers to the questions posed by the computing system to select additional questions to pose to the viewer.

For example, if the viewer correctly answers a few questions about a first topic covered during the segment, then the computing system may pose questions about a second topic covered during that segment. But if the viewer incorrectly answers one or more questions about the first topic, then the computing system may continue to pose questions about the first topic, and provide further information to the viewer about that first topic before posing questions about the second topic. In operation, selection of questions and follow-up questions presented at the end of chapters, segments, or similar breaks is the same or substantially the same as the selection of responses described in detail previously. For example, the selection of the end-of-segment follow-up questions may be pre-configured by the system (e.g., input by the creator as a follow-up or related question, generated by a generative model and possibly approved by the creator, etc.) or dynamically determined (e.g., by a generative model) based on the training data in the knowledge base, including but not limited to the pre-configured questions in the knowledge base.

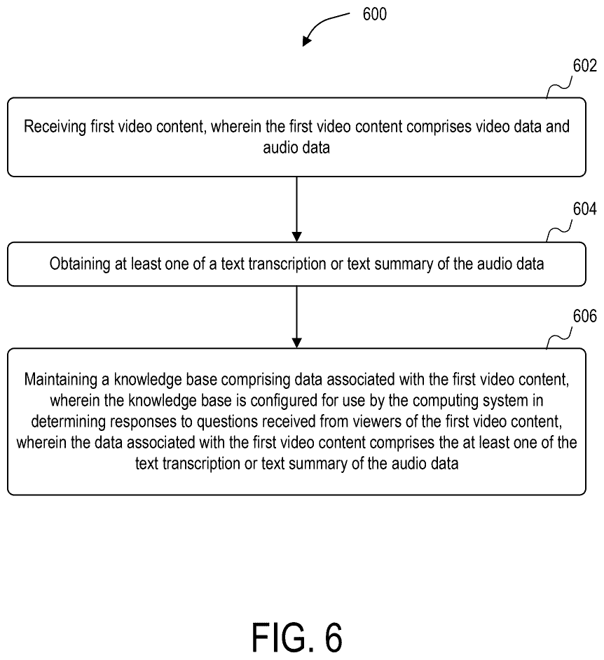

FIG. 6 shows an example method of creating and maintaining a knowledge base of interactive video content according to some embodiments.

Method 600 may be performed by any one or more computer devices or systems, individually or in combination with each other. For example, in some embodiments, an end-user computing device 106 (FIG. 1) such as computing device 300 (FIG. 3) may perform one or more (or all) of the method 600 functions. In other embodiments, a cloud system or back-end platform 104 (FIG. 1) such as computing platform 200 (FIG. 2) may perform or more (or all) of the method 600 functions. In still further embodiments, an end-user computing device may perform some of the method 600 functions while a cloud system or back-end platform may perform other method 600 functions. Thus, in operation, a computing system configured to perform method 600 may include one or both of an end-user computing device and/or a back-end platform.

Method 600 begins at method block 602, which includes receiving first video content, wherein the first video content comprises video data and audio data. In operation, the first video content may include any of (i) a video file, (ii) a link to a video, (iii) a recording of a live stream, and/or (iv) video content in any other suitable form.

Next, method 600 proceeds to method block 604, which includes obtaining at least one of a text transcription or text summary of the audio data of the first video content.

In some examples that include obtaining the text transcription of the audio data, the step of obtaining the text transcription of the audio data comprises one of (i) obtaining the transcription from a creator of the first video content, or (ii) generating the transcription by performing functions comprising (a) separating the audio data of the first video content from the video data of the first video content, (b) identifying at least one voice in the audio data and associating the at least one voice in the audio data with a corresponding character depicted in the video data of the first video content. In some embodiments, the transcription may be obtained by applying one or more speech-to-text algorithms to the audio data. In other embodiments, the transcription may be available in the form of a transcript.

In some examples where the video includes more than one speaking character, the audio data is analyzed to identify each speaking character's dialog. For example, if the video includes three speaking characters, the first speaking character's dialog is associated with the first speaking character, the second speaking character's dialog is associated with the second speaking character, and the third speaking character's dialog is associated with the third speaking character. In some instances where a transcript is available, the dialog may already be associated with the different speaking characters. In some embodiments, the content creator may tag or otherwise associate dialog with the different speaking characters.

In some embodiments, after separating the audio data of the first video content from the video data of the first video content, the video data can be analyzed to extract gestures, mannerisms, moods, presentation style, and/or other aspects of a speaking character depicted in the first video content. In some embodiments, extracting the gestures, mannerisms, moods, presentation style, and/or other aspects of a speaking character can be performed by the components of the conversation analysis component 210 (FIG. 2).

For example, the video processor 218 (FIG. 2) may be used to analyze the speaking character in the video for visual cues that may not be readily apparent in the audio data of the video content, such as the speaking character's body language. In some instances, the video processor 218 (FIG. 2) may employ various machine learning methods, such as convolutional neural networks, recurrent neural networks, and/or capsule networks, to analyze video segments and/or captured images to identify features that can be used to analyze the speaking character's body language. This extracted information can then be used by the conversation generation component 220 (FIG. 2) in connection with generating a digital character version of the speaking character in the video. As described further herein, some embodiments include generating a response to a viewer's question in the form of a text-based script, and then having a digital character version of the speaking character shown in the video read the text-based script.

In some examples, when obtaining at least one of the text transcription or text summary of the audio data at method block 604 includes obtaining the text summary of the audio data, the step of obtaining the text summary of the audio data comprises obtaining the text summary of the audio from a text summarization model configured to generate the text summary of the audio data based on the text transcription of the audio data. In some embodiments, the text summarization model comprises a large language model (LLM) configured to perform natural language processing (NLP) of the transcription.

In some instances, the LLM is configured to (i) identify two or more different sections within the transcript and the video time markers associated with each section, and (ii) summarize each identified section. These sections can be used to determine natural breaks in the video content where, in some embodiments, the interactive video may be configured to prompt the viewer for questions.

Next, method 600 advances to method block 606, which includes maintaining a knowledge base comprising data associated with the first video content, wherein the knowledge base is configured for use by the computing system in determining responses to questions received from viewers of the first video content, where the data associated with the first video content comprises the at least one of the text transcription or text summary of the audio data. As described above with reference to FIG. 2 and FIG. 3, the data within the knowledge base can also be used to create more data for the knowledge base.

In some embodiments, the knowledge base of method block 606 is the same as or similar to knowledge base 240 (FIG. 2), knowledge base 340 (FIG. 3), and/or any other knowledge base disclosed or described herein. In operation, the knowledge base of method 606 may include any one or more (or all) of the various types of information provided by a content creator and/or generated by a generative model (and perhaps approved by the content creator) disclosed and/or described herein, in any combination.

For example, in some embodiments, the knowledge base of method block 606 includes one or more (or all) of: (i) a library of provided (by the content creator) and/or generated (by a generative model) “expected questions” related to the first video content that viewers might ask, including perhaps generated questions approved by the content creator; (ii) a library of pre-recorded (by the content creator) and/or pre-generated (by the generative model) video responses to the expected questions (provided by the content creator or generated by the generative model) relating to the first video content, including perhaps pre-generated (by the generative model) video responses approved by the content creator; (iii) a library of prepared (by the content creator) and/or pre-generated (by the generative model) text-based responses to expected questions (provided by the content creator or generated by the generative model) relating to the first video content, including perhaps pre-generated (by the generative model) text-based responses approved by the content creator; (iv) a library of prepared (by the content creator) and/or pre-generated (by the generative model) voice responses to expected questions (provided by the content creator or generated by the generative model) relating to the first video content, including perhaps pre-generated (by the generative model) voice responses approved by the content creator; (v) a library of text-based content (provided by the content creator or generated by the generative model) corresponding to the first video content; (vi) a library of one or more presentations (provided by the content creator or generated by the generative model) corresponding to the first video content; (vii) a library of Uniform Resource Locators (URLs) pointing to information related to the first video content; (viii) a running collection of questions posed by viewers with an indication of which response(s) were provided to each question, (ix) viewer feedback regarding responses, including whether and/or the extent to which the viewer felt like the response provided by the system adequately answered the question posed, and/or (x) operational metrics relating to playback of the video content, including metrics relating to viewer engagement, viewer actions (fast forward, skipping, re-watching), topics the viewers asked questions about, and so on. The knowledge base may include any other information about the video content disclosed and/or described herein, including information provided by the content creator, information generated by the generative model, and/or feedback or operational metrics.

In some embodiments, and as described herein in detail, method 600 additionally includes generating at least a portion of the knowledge base that is maintained at method block 606.

In some embodiments, generating at least a portion of the knowledge base includes receiving pre-recorded video responses from a creator of the first video content, and associating individual pre-recorded video responses with one or more expected questions. In some embodiments, generating the knowledge base additionally or alternatively includes receiving text-based responses from the creator of the first video content, and associating individual text-based responses with one or more expected questions.

In some embodiments, generating the knowledge base includes one or both of (i) generating one or more questions using a generative model trained with a dataset comprising data corresponding to the first video content, and storing the one or more questions in the knowledge base, and/or (ii) generating one or more responses to one or more questions using the generative model trained with the dataset comprising data corresponding to the first video content, and storing the one or more responses in the knowledge base. In some examples, the generative model comprises a Generative Pre-trained Transformer (GPT) model. In other examples, the generative model includes any generative model now known or later developed that is suitable for generating questions and/or responses to questions based on training data.

In embodiments that include generating questions and/or responses using the generative model trained with the dataset comprising data corresponding to the first video content, the dataset comprising data corresponding to the first video content includes one or more (or all) of: (i) a text transcription of the audio data of the interactive video; (ii) a text summary of the audio data of the interactive video; (iii) a text summary of the video data of the interactive video; (iv) data provided by a creator of the interactive video, such as questions and responses prepared by the content creator, including (a) pre-recorded video responses to expected questions relating to the interactive video, (b) prepared text-based responses to expected questions relating to the interactive video, and/or (c) prepared voice responses to expected questions relating to the interactive video; (v) text-based content corresponding to the interactive video; (vi) one or more presentations or other documents associated with to the interactive video; (vii) one or more Uniform Resource Locators (URLs) pointing to information related to the interactive video; (viii) data obtained from Internet searches of keywords extracted from one or both of the text transcription of the audio data of the interactive video and/or the data provided by the creator of the interactive video; (ix) text from viewer comments relating to the interactive video; (x) prior questions received from viewers of the interactive video; (xi) prior responses provided by the computing system to prior questions received from viewers of the interactive video; and/or (xv) pre-generated questions and/or pre-generated responses that have been previously generated by the generative model.

In some embodiments, generating and/or maintaining knowledge base of method block 606 additionally includes (i) tracking interaction data comprising questions asked by viewers, responses provided by the computing system, and viewer reaction to the responses provided by the computing system, and (ii) updating the knowledge base based on the interaction data.

For example, as described previously with reference to FIG. 2, some embodiments may include collecting feedback from viewers on the quality and/or relevance of responses provided while the viewer was watching the interactive video, and using the viewer feedback as another metric via which to score and/or rank candidate responses in connection with determining a response to a question posed by a viewer during playback of the interactive video.

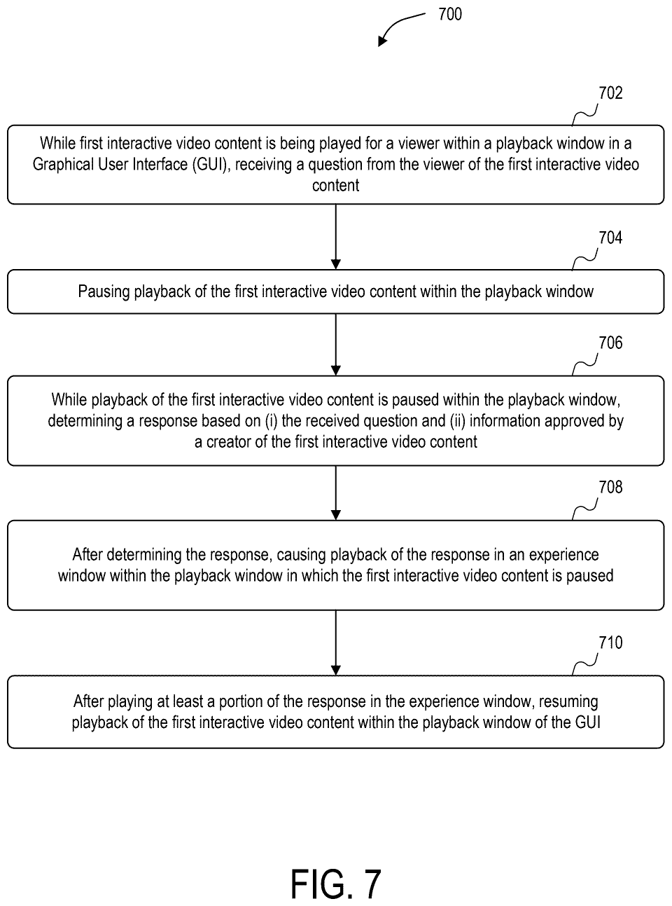

FIG. 7 shows another example method 700 for implementing interactive video according to some embodiments. Method 700 may be performed by any one or more computer devices or systems, individually or in combination with each other. For example, in some embodiments, an end-user computing device 106 (FIG. 1) such as computing device 300 (FIG. 3) may perform one or more (or all) of the method 700 functions. In other embodiments, a cloud system or back-end platform 104 (FIG. 1) such as computing platform 200 (FIG. 2) may perform or more (or all) of the method 700 functions. In still further embodiments, an end-user computing device may perform some of the method 700 functions while a cloud system or back-end platform may perform other method 700 functions. Thus, in operation, a computing system configured to perform method 700 may include one or both of an end-user computing device and/or a back-end platform.

Method 700 begins at method block 702, which includes while first interactive video content is being played for a viewer within a playback window in a Graphical User Interface (GUI), receiving a question from the viewer of the first interactive video content. For example, in some instances, receiving the question from the viewer of the first video content at method block 702 includes receiving text corresponding to at least one of (i) a question typed by the viewer via a GUI, (ii) a speech-to-text translation of a question spoken by the viewer, or (iii) a question selected by the viewer from a set of questions presented within the GUI. However, in some embodiments, and as described above, receiving a question from a viewer of the first video content in method block 702 includes the computing system receiving a voice input comprising the question via one or more microphones of the viewer's end-user computing device without the viewer first activating any particular prompt that may (or may not) be displayed via any GUI.

In some embodiments, receiving the question from the viewer of the first interactive video content at block 702 includes receiving text corresponding to at least one of (i) a question typed by the viewer via the experience window, (ii) a speech-to-text translation of a question spoken by the viewer, or (iii) a question selected by the viewer from a set of questions presented within the experience window.

In some embodiments, while first interactive video content is being played for a viewer within the playback window of the GUI, receiving a question from the viewer of the first interactive video content at block 702 includes causing display of a prompt to the viewer that solicits a question from the viewer.

Next, method 700 advances to block 704, which includes pausing playback of the first interactive video content within the playback window. In some embodiments, it may be advantageous to pause playback of the first interactive video content upon detecting that the viewer wishes to pose a question, for example, as shown and described with reference to FIG. 4B. In some embodiments, playback of the first interactive video content may not be paused until the viewer has finished posing the question. In some embodiments, pausing the playback of the first interactive video content at block 704 includes determining a natural place to stop/pause the interactive video after receiving the viewer question at block 702. For example, a natural stopping place may be after the speaking character has finished speaking a sentence or after the speaking character has finished speaking a set of closely-related sentences. In embodiments where the text transcript of the interactive video content is divided into paragraphs and/or other sections, pausing playback at block 704 may include pausing playback at the end of a paragraph and/or similar section.

In some multi-viewer embodiments, pausing playback of the first interactive video content at block 704 may include pausing playback only if more than some threshold number of viewers in the multi-viewer session have reached consensus on pausing playback of the first video content. For example, as described above, if some minimum threshold of viewers reach consensus on pausing the interactive video to hear the response to one viewer's question, then playback of the first interactive video content is paused so that the response can be played. But if an insufficient number of viewers agree to pausing playback, then the viewer question may be held until the end of the multi-viewer session (or perhaps a scheduled break in the multi-viewer session). And then at the end of the multi-viewer session (or during the scheduled break), the response can be played (e.g., at block 708) to the viewer and one or more other viewers who elect to hear the response

Next, method 700 advances to block 706, which includes while playback of the first interactive video content is paused within the playback window, determining a response based on (i) the received question and (ii) information approved by a creator of the first interactive video content.

In some embodiments, determining a response at block 706 based on (i) the question and (ii) information approved by a creator of the first interactive video content includes at least one of (a) selecting a response to the question from a knowledge base comprising pre-configured responses based on a natural language processing of the question, wherein the pre-configured responses have been approved by the creator of the first interactive video content, or (b) generating a natural language response to the question using a generative model trained with a dataset comprising data corresponding to the first interactive video content, wherein the dataset used for training has been approved by the creator of the first interactive video content.

In some instances the response at block 706 is selected from a library of responses that have been prepared in advance by the content creator and/or generated in advance by a generative model as described in detail earlier. In some embodiments, a knowledge base contains the library of prepared (and/or pre-generated) responses, and the step of determining a response at block 706 based on the question received at block 702 includes selecting the response from a knowledge base containing the library of prepared (and/or pre-generated) responses. In some embodiments, the knowledge base is the same as or similar to knowledge base 240 (FIG. 2), knowledge base 340 (FIG. 3), and/or any other knowledge base disclosed or described herein. In operation, the knowledge base containing the library of prepared (and/or pre-generated) responses is created and/or maintained according to any of the previously-described methods of generating and/or maintaining a knowledge base associated with interactive video.

For example, in some embodiments, the response determined at block 706 includes one or more of: (i) a pre-recorded (or pre-generated) video response associated with the question received at block 702; (ii) a prepared (or pre-generated) text-based response associated with the question received at block 702; (iii) a prepared (or pre-generated) voice response associated with the question at block 702; (iv) a presentation or other document associated with the question received at block 702; and/or (v) a Uniform Resource Locator (URLs) associated with the question from block 702 that points to information related to the question from block 702. As described previously, in some instances, the response may include a follow up question posed back to the viewer. In some examples, the follow up question may seek further information from the viewer to help refine or clarify the viewer's question, or perhaps to obtain information about the viewer's knowledge and/or experience. In such examples, the viewer's answer to the follow up question is used (perhaps in combination with the viewer's initial question that spawned the follow up question) to select a response to the viewer's initial question that has an appropriate level of detail for the viewer.

In some instances, the response at block 706 is a response generated in “real time” using a generative model such as a Generative Pre-trained Transformer (GPT) model. However, other suitable generative models could be used as well (or instead). In some embodiments, the generative model is trained with a dataset comprising data corresponding to the first video content. As mentioned earlier, the first video content in some embodiments includes video data and audio data.

In such embodiments, the dataset comprising data corresponding to the first video that is used to train the generative model may include, any one or more (or all) of: (i) a text transcription of the audio data of the interactive video; (ii) a text summary of the audio data of the interactive video; (iii) a text summary of the video data of the interactive video; (iv) data provided by a creator of the interactive video, such as questions and responses prepared by the content creator, including (a) pre-recorded video responses to expected questions relating to the interactive video, (b) prepared text-based responses to expected questions relating to the interactive video, and/or (c) prepared voice responses to expected questions relating to the interactive video; (v) text-based content corresponding to the interactive video; (vi) one or more presentations or other documents associated with to the interactive video; (vii) one or more Uniform Resource Locators (URLs) pointing to information related to the interactive video; (viii) data obtained from Internet searches of keywords extracted from one or both of the text transcription of the audio data of the interactive video and/or the data provided by the creator of the interactive video; (ix) text from viewer comments relating to the interactive video; (x) prior questions received from viewers of the interactive video; (xi) prior responses provided by the computing system to prior questions received from viewers of the interactive video; and/or (xv) pre-generated questions and/or pre-generated responses that have been previously generated by the generative model.

Next, method 700 advances to block 708, which includes after determining the response, causing playback of the response in an experience window within the playback window in which the first interactive video content is paused. In some embodiments, causing playback of the response at block 708 may additionally or alternatively include causing playback via means other than the GUI. For example, as described earlier, in embodiments where the response is only audio, the response may be played via one or more speakers while playback of the video is paused in the playback window in the GUI. Further, and as described previously, playback of the response may include coordinating playback of the response via an end-user computing device that is different than the end-user computing device that is playing the video. Still further, and as explained earlier, playing of the response may additionally or alternatively include coordinating playback of the response via two or more end-user computing devices, including (i) scenarios where one of the two or more end-user computing devices is the end-user device configured to play the first video content and/or (ii) scenarios where neither of the two or more end-user computing devices is the end-user device configured to play the first video content.

In some embodiments, the response played at block 708 includes one or more of (i) a text response displayed within the experience window, (ii) a voice response played within the experience window, (ii) second video content played within the experience window, (iii) a Uniform Resource Locator (URL) displayed within the experience window, wherein the URL contains a link to information relating to the question, or (iv) an electronic document displayed within the experience window.

In some embodiments, the first interactive video content played for the viewer within the playback window of the GUI at block 702 includes a speaking character, and the response played at block 708 includes a voice response derived from a voice of the speaking character. In some such embodiments, the speaking character includes one of (i) a speaking character shown in the first interactive video content or (ii) a speaking character not shown in the first interactive video content.

In some embodiments where the first video content comprises a speaking character and the response played at method block 708 includes second video content selected from the library of pre-recorded and/or pre-generated video content, the second video content comprises video of the speaking character.

In some embodiments, the first interactive video content played for the view within the playback window of the GUI at block 702 includes a speaking character, and the response played at block 708 includes second interactive video content. In some such embodiments, the second interactive video content includes a computer-generated character. In some examples, the computer-generated character is one of (i) a computer-generated version of the speaking character in the first interactive video content or (ii) a computer-generated character different than the speaking character in the first interactive video content.

In some embodiments, the response played at block 708 includes second interactive video content selected from a library of pre-recorded interactive video content.

In some embodiments, the response played at block 708 includes second interactive video content, and causing playback of the response at block 708 includes causing the second interactive video content to play in a same playback window as the first interactive video content. In some embodiments, causing playback of the response at block 708 includes causing the second interactive video content to play within the experience window.

In some embodiments, the response played at block 708 comprises a second question presented by the computing system to the viewer. In some such embodiments, method 700 additionally includes, among other features, (i) receiving a second response from the viewer in response to the second question presented by the computing system, (ii) determining a third response based on the second response from the viewer, wherein the third response is based on (a) the second response and (b) the information approved by the creator the first interactive video content, and (iii) after determining the third response, causing playback of the third response in the experience window within the playback window in which the first interactive video content is paused.

In some embodiments, the response at block 708 includes (i) a voice response and (ii) a portion of the first interactive video content. In some such embodiments, causing playback of the response at block 708 includes causing playback of the voice response with the portion of the first interactive video content.

In some embodiments, the response played at block 708 includes a portion of the first interactive video content. For example, if the first interactive video content covers three topics and the viewer asks a question about the second topic during playback of the portion of the first video addressing the first topic, then the response played at block 708 might include a portion of the first video addressing the second topic.

For example, after the viewer has posed a question at block 702, the response provided from the computing system may take the viewer to another part of the interactive video that contains an answer to the viewer's question. In some instances, the viewer's question may even be an express request to go to the other part of the interactive video, such as, “Can you take me to where the presenter was talking about the changing the air filter?”

But even if the question is not an explicit request to go to another part of the video (e.g., “How do you change the air filter?”), the response may include (i) a statement such as “Changing the air filter is covered later in this video. Let me take you there now.” and (ii) then playing the portion of the video that shows changing the air filter. Then, after playing the portion of the video that shows changing the air filter, playback of the video can be resumed at the point where the viewer asked the question about changing the air filter, for example in the manner described below with reference to method block 710.

In some instances where the response played at method block 708 includes (i) a voice response and (ii) a portion of the first interactive video content, causing playback of the response at block 708 includes causing playback of the voice response with the portion of the first interactive video content.

In some embodiments, the response played at block 708 includes a second question (e.g., a follow up question as described previously) that is responsive to the viewer question from method block 702. In some instances, the second question may ask the viewer to clarify one or more aspects of the viewer question from method block 702. In some embodiments where the response played at block 708 includes a second question responsive to the viewer question from block 702, method 700 additionally includes (i) receiving a second response from the viewer (i.e., the viewer's response), and (ii) determining a third response based on the viewer's response. In operation, determining the third response based on the viewer's response is similar to the block 704 step of determining a response based on the viewer question from block 702.

In some instances, causing playback of the response at block 708 includes causing the response to play in at least one of (i) the same window (e.g., within an experience window) as the first interactive video content, (ii) a smaller window within the main window playing first video content, or (iii) a second window separate from the main window playing the first video content, including but not limited to a second window adjacent to the main window. In some instances, the second window adjacent to the main window does not overlap or otherwise obscure any portion of the main window, thereby enabling the viewer to see both the paused first video within the main and the response in the second window. In some embodiments, the main window may be resized so that the second window with the response can be displayed without obscuring any portion of the main window. For example, as described previously, in some instances, playback of the response may be coordinated among two or more end-user computing devices.

For example, in some embodiments where the response played at block 708 is a text response, causing playback of the response at block 706 may include displaying the text response in a smaller window within the window of the first interactive video content. In another example where the response played at block 708 includes second video content, causing playback of the response at block 708 may include playing the second video content in the same window as the first video content, e.g., within a common experience window. In yet another example where the response played at block 708 includes a presentation, causing playback of the response at block 708 may include playing the presentation in a window separate from the GUI window of the first video content.

Other combinations of response type (e.g., text, video, document) and display mode (e.g., same window as the first video content, smaller window within the window of the first video content, and window separate from the window of the first video content) are contemplated, too. Further, in embodiments where the response played at method block 708 is an audio-only response, causing playback of the response at block 708 may include playing the audio-only even without a separate window or any modification to the window in which the first interactive video content is played and/or paused.

Next, method 700 advances to block 710, which includes after playing at least a portion of the response in the experience window, resuming playback of the first interactive video content within the playback window of the GUI.

In some embodiments, resuming playback of the first interactive video content within the playback window at block 710 includes at least one of (i) resuming playback of the first interactive video content from a point in the first interactive video content where the first interactive video content was paused before causing playback of the response; or (ii) resuming playback of the first interactive video content from a point in the first interactive video content that is different from the point in the first interactive video content where the first interactive video content was paused before causing playback of the response.

Some embodiments may additionally include the computing system initiating feedback from the viewer during playback of the interactive video.

For example, in some instances, the computing system is configured to pause playback of the interactive video and pose one or more questions to the viewer to answer. In some examples, after identifying an appropriate stopping point during playback (e.g., at the end of a segment, chapter, module, or similar), the computing system may pose questions about the subject matter covered in the previous segment or chapter. The questions posed to the viewer may be provided by the content creator, or generated by the generative model based on the data contained within the knowledge base. In operation, the generative model generates questions to pose to viewers at the end of segments in substantially the same way that the generative model generates potential questions and responses described above. In some examples, in addition to or instead of posing questions to the viewer, the computing system may display keywords or topics as an overlay to the video so that the viewer can select the displayed keywords or topics to obtain further information. In some instances, the computing system can use the viewer's answers to the questions posed by the computing system to select additional questions to pose to the viewer.

For example, if the viewer correctly answers a few questions about a first topic covered during the segment, then the computing system may pose questions about a second topic covered during that segment. But if the viewer incorrectly answers one or more questions about the first topic, then the computing system may continue to pose questions about the first topic, and provide further information to the viewer about that first topic before posing questions about the second topic. In operation, selection of questions and follow-up questions presented at the end of chapters, segments, or similar breaks is the same or substantially the same as the selection of responses described in detail previously. For example, the selection of the end-of-segment follow-up questions may be pre-configured by the system (e.g., input by the creator as a follow-up or related question, generated by a generative model and possibly approved by the creator, etc.) or dynamically determined (e.g., by a generative model) based on the training data in the knowledge base, including but not limited to the pre-configured questions in the knowledge base.

### V. Conclusion

Example embodiments of the disclosed innovations have been described above. Those skilled in the art will understand, however, that changes and modifications may be made to the embodiments described without departing from the true scope and spirit of the present invention, which will be defined by the claims.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the method diagrams and/or described herein do not necessarily require the particular order shown, or sequential order, to achieve desirable results. Other implementations may be within the scope of the following claims.

Further, to the extent that examples described herein involve operations performed or initiated by actors, such as “viewers,” “humans,” “users,” or other entities, this is for purposes of example and explanation only. Claims should not be construed as requiring action by such actors unless explicitly recited in claim language.

What is claimed is:

1. Tangible, non-transitory computer-readable media comprising program instructions, wherein the program instructions, when implemented by one or more processors, cause a computing system to perform functions comprising:
while first interactive video content is being played for a viewer within a playback window in a Graphical User Interface (GUI), receiving a question from the viewer of the first interactive video content;
pausing playback of the first interactive video content within the playback window;
while playback of the first interactive video content is paused within the playback window, determining a response based on (i) the received question and (ii) information approved by a creator of the first interactive video content;
after determining the response, causing playback of the response in an experience window within the playback window in which the first interactive video content is paused; and
after playing at least a portion of the response in the experience window, resuming playback of the first interactive video content within the playback window of the GUI.

2. The tangible, non-transitory computer-readable media of claim 1, wherein the response comprises a second question presented by the computing system to the viewer, and wherein the functions further comprise:
receiving a second response from the viewer in response to the second question presented by the computing system;
determining a third response based on the second response from the viewer, wherein the third response is based on (i) the second response and (ii) the information approved by the creator the first interactive video content; and
after determining the third response, causing playback of the third response in the experience window within the playback window in which the first interactive video content is paused.

3. The tangible, non-transitory computer-readable media of claim 1, wherein resuming playback of the first interactive video content within the playback window comprises one of:
resuming playback of the first interactive video content from a point in the first interactive video content where the first interactive video content was paused before causing playback of the response; or
resuming playback of the first interactive video content from a point in the first interactive video content that is different from the point in the first interactive video content where the first interactive video content was paused before causing playback of the response.

4. The tangible, non-transitory computer-readable media of claim 1, wherein receiving the question from the viewer of the first interactive video content comprises receiving text corresponding to at least one of (i) a question typed by the viewer via the experience window, (ii) a speech-to-text translation of a question spoken by the viewer, or (iii) a question selected by the viewer from a set of questions presented within the experience window.

5. The tangible, non-transitory computer-readable media of claim 1, wherein the response comprises one or more of (i) a text response displayed within the experience window, (ii) a voice response played within the experience window, (ii) second video content played within the experience window, (iii) a Uniform Resource Locator (URL) displayed within the experience window, wherein the URL contains a link to information relating to the question, or (iv) an electronic document displayed within the experience window.

6. The tangible, non-transitory computer-readable media of claim 1, wherein the first interactive video content comprises a speaking character, wherein the response comprises a voice response derived from a voice of the speaking character, and wherein the speaking character comprises one of (i) a speaking character shown in the first interactive video content or (ii) a speaking character not shown in the first interactive video content.

7. The tangible, non-transitory computer-readable media of claim 1, wherein the first interactive video content comprises a speaking character and wherein the response comprises a second interactive video content, wherein the second interactive video content comprises a computer-generated character, and wherein the computer-generated character is one of (i) a computer-generated version of the speaking character in the first interactive video content or (ii) a computer-generated character different than the speaking character in the first interactive video content.

8. The tangible, non-transitory computer-readable media of claim 1, wherein the response comprises a second interactive video content selected from a library of pre-recorded interactive video content.

9. The tangible, non-transitory computer-readable media of claim 1, wherein the response comprises second interactive video content, and wherein causing playback of the response comprises:
causing the second interactive video content to play in a same playback window as the first interactive video content.

10. The tangible, non-transitory computer-readable media of claim 1, wherein the response comprises (i) a voice response and (ii) a portion of the first interactive video content, and wherein causing playback of the response comprises:
causing playback of the voice response with the portion of the first interactive video content.

11. The tangible, non-transitory computer-readable media of claim 1, wherein determining a response based on (i) the question and (ii) information approved by a creator of the first interactive video content comprises one of:
selecting a response to the question from a knowledge base comprising pre-configured responses based on a natural language processing of the question, wherein the pre-configured responses have been approved by the creator of the first interactive video content; or
generating a natural language response to the question using a generative model trained with a dataset comprising data corresponding to the first interactive video content, wherein the dataset used for training has been approved by the creator of the first interactive video content.

12. The tangible, non-transitory computer-readable media of claim 1, wherein while first interactive video content is being played for a viewer within the playback window of the GUI, receiving a question from the viewer of the first interactive video content comprises:
causing display of a prompt to the viewer that solicits a question from the viewer.

13. Tangible, non-transitory computer-readable media comprising program instructions, wherein the program instructions, when implemented by one or more processors, cause a computing system to perform functions comprising:
receiving first video content, wherein the first video content comprises video data and audio data;
obtaining at least one of a text transcription or text summary of the audio data;
maintaining a knowledge base comprising data associated with the first video content, wherein the knowledge base is configured for use by the computing system in determining responses to questions received from viewers of the first video content, wherein the data associated with the first video content comprises at least one of the text transcription or text summary of the audio data; and
generating interactive video content based on the first video content and the knowledge base.

14. The tangible, non-transitory computer-readable media of claim 13, wherein when obtaining at least one of the text transcription or text summary of the audio data comprises obtaining the text transcription of the audio data, obtaining the text transcription of the audio data comprises one of (i) obtaining the text transcription from a creator of the first video content; or (ii) generating the text transcription by performing functions comprising (a) separating the audio data of the first video content from the video data of the first video content, (b) identifying at least one voice in the audio data and associating the at least one voice in the audio data with a corresponding character depicted in the video data of the first video content.

15. The tangible, non-transitory computer-readable media of claim 13, wherein when obtaining at least one of the text transcription or text summary of the audio data comprises obtaining the text summary of the audio data, obtaining the text summary of the audio data comprises:
obtaining the text summary of the audio data from a text summarization model configured to generate the text summary of the audio data based on the text transcription of the audio data.

16. The tangible, non-transitory computer-readable media of claim 13, wherein the knowledge base comprising data associated with the first video content comprises one or more of:
a library of pre-recorded video responses to expected questions relating to the first video content;
a library of prepared text-based responses to expected questions relating to the first video content;
a library of prepared voice responses to expected questions relating to the first video content;
a library of text-based content corresponding to the first video content;
a library of one or more presentations corresponding to the first video content; or
a library of Uniform Resource Locators (URLs) pointing to information related to the first video content.

17. The tangible, non-transitory computer-readable media of claim 13, further comprising generating the knowledge base, wherein generating the knowledge base comprises one or more of:
receiving pre-recorded video responses from a creator of the first video content, and associating individual pre-recorded video responses with one or more expected questions; and
receiving text-based responses from the creator of the first video content, and associating individual text-based responses with one or more expected questions.

18. The tangible, non-transitory computer-readable media of claim 13, further comprising generating at least a portion of the knowledge base, wherein generating at least a portion of the knowledge base comprises one or both of:
generating one or more questions using a generative model trained with a dataset comprising data corresponding to the first video content, and storing the one or more questions in the knowledge base; and
generating one or more responses to one or more questions using the generative model trained with the dataset comprising data corresponding to the first video content, and storing the one or more responses in the knowledge base.

19. The tangible, non-transitory computer-readable media of claim 18, wherein the data corresponding to the first video content comprises one or both of: (i) the text transcription of the audio data of the first video content; and (ii) data provided by a creator of the first video content.

20. The tangible, non-transitory computer-readable media of claim 19, wherein the data corresponding to the first video content further comprises data obtained from Internet searches of keywords extracted from one or both of: (i) the text transcription of the audio data of the first video content; and (ii) the data provided by a creator of the first video content.

21. The tangible, non-transitory computer-readable media of claim 18, wherein the data corresponding to the first video content comprises (i) text from viewer comments relating to the first video content, (ii) prior questions received from viewers of the first video content, and (iii) prior responses provided by the computing system to prior questions received from viewers of the first video content.

22. The tangible, non-transitory computer-readable media of claim 18, wherein the generative model comprises a Generative Pre-trained Transformer (GPT) model.

23. The tangible, non-transitory computer-readable media of claim 13, wherein the functions further comprise:
tracking interaction data comprising questions asked by viewers, responses provided by the computing system, and viewer reaction to the responses provided by the computing system; and
updating the knowledge base based on the interaction data.
